(19) United States
(12) Patent Application Publication
(10) Pub. No.: US 2010/0271650 A1
(43) Pub. Date: Oct. 28, 2010

(54) DATA PROVIDING METHOD AND IMAGE FORMING APPARATUS

(75) Inventors: Hajime Tomizawa, Shizuoka-ken (JP); Akihiko Fujiwara, Kanagawa-ken (JP); Shinji Makishima, Shizuoka-ken (JP); Kazuhiro Ogura, Kanagawa-ken (JP); Akihiro Mizutani, Shizuoka-ken (JP); Toshihiro Ida, Shizuoka-ken (JP); Yusuke Hamada, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/767,875

(22) Filed: Apr. 27, 2010

Related U.S. Application Data
(60) Provisional application No. 61/173,316, filed on Apr. 28, 2009.
(60) Provisional application No. 61/173,318, filed on Apr. 28, 2009.
(60) Provisional application No. 61/173,323, filed on Apr. 28, 2009.

(51) Int. Cl. G06F 3/12; G06F 15/173; G06F 17/30; G06K 15/02; G06F 15/16

(52) U.S. Cl. 358/1.13; 709/225; 707/740; 358/1.15; 358/1.14; 709/246; 707/E17.09

(57) ABSTRACT

A data providing method comprises performing contactless communication with a mobile device brought close to the relay, selecting an appropriate workspace that is appropriate for unique information representing the status of the contactless communication with the mobile device from a plurality of workspaces that collects a plurality of information related to each task, sending information of the selected appropriate workspace to the mobile device by the contactless communication, and allowing the mobile device to access the appropriate workspace in response to an access request for the appropriate workspace from the mobile device.

### CROSS-REFERENCE TO RELATED APPLICATIONS

This application claims the benefit of U.S. Provisional Applications No. 61/173,316, filed Apr. 28, 2009; No. 61/173,318, filed Apr. 28, 2009; and No. 61/173,323, filed Apr. 28, 2009.

### TECHNICAL FIELD

Embodiment described herein relate generally to a data providing method used in a data sharing system in which a plurality of users shares data such as documents and an image forming apparatus.

### BACKGROUND

Conventionally, there is known a data sharing system in which a plurality of users shares data such as documents. In the conventional data sharing system, users are able to download shared data to the user terminals by accessing a data management device that manages the shared data from the user terminals being operated by the users. An example of such a related art technique is disclosed in US Patent Publication No. 2006/264239. However, the technique disclosed in US Patent Publication No. 2006/264239 has a problem in that a mobile device such as an IP telephone terminal possessed by each user needs to acquire the storage address of shared data in order to acquire the shared data.

### DESCRIPTION OF THE DRAWING

The accompanying drawings, which are incorporated in and constitute a part of the specification, and together with the general description given above and the detailed description of the embodiments given below.

FIG. 1 is a diagram showing an exemplary hardware configuration of a document system which is a data sharing system.

FIG. 2 is a diagram showing an exemplary functional configuration of the document system according to a first embodiment.

FIG. 3 is a diagram showing an example of workspaces that are managed by a workspace management unit.

FIG. 4 is a diagram showing a display example of a workspace control screen on a PC.

FIG. 5 is a diagram showing an example of information that is managed as unique information of a relay.

FIG. 6 is a flowchart showing a relay operation wherein a relay allows a smart phone to access a workspace.

FIG. 7 is a diagram showing an example of access history information that is stored in a workspace access history storage unit.

FIG. 8 is a diagram showing an example of workspace information that is displayed on a display unit.

FIG. 9 is a flowchart showing a processing example of the smart phone according to the first embodiment.

FIG. 10 is a diagram showing a display example of accessed workspaces.

FIG. 11 is a flowchart showing the functions of a business device operation unit.

FIG. 12 is a diagram showing an exemplary functional configuration of the document system according to a second embodiment.

FIG. 13 is a diagram showing an example of workspaces that are managed by a workspace management unit in the document system according to the second embodiment.

FIG. 14 is a diagram showing an example of information that is stored in a mobile device information storage unit.

FIG. 15 is a flowchart showing the operation of allowing a smart phone to download a document file of a workspace.

FIG. 16 is a diagram showing an exemplary functional configuration of the document system according to a third embodiment.

FIG. 17 is a diagram showing an example of private print jobs that are managed by a private print management unit.

FIG. 18 is a flowchart showing the operation of transferring print data of private print jobs.

FIG. 19 is a diagram showing a display example of private print jobs.

### DETAILED DESCRIPTION

Hereinafter, embodiments of the invention will be described with reference to the drawings.

In general, according to one embodiment, a data providing method performed by a relay, the method comprising: performing contactless communication with a mobile device brought close to the relay; selecting an appropriate workspace that is appropriate for unique information representing the status of the contactless communication with the mobile device from a plurality of workspaces that collects a plurality of information related to each task; sending information of the selected appropriate workspace to the mobile device by the contactless communication; and the relay allowing the mobile device to access the appropriate workspace in response to an access request for the appropriate workspace from the mobile device.

First, the first embodiment will be described.

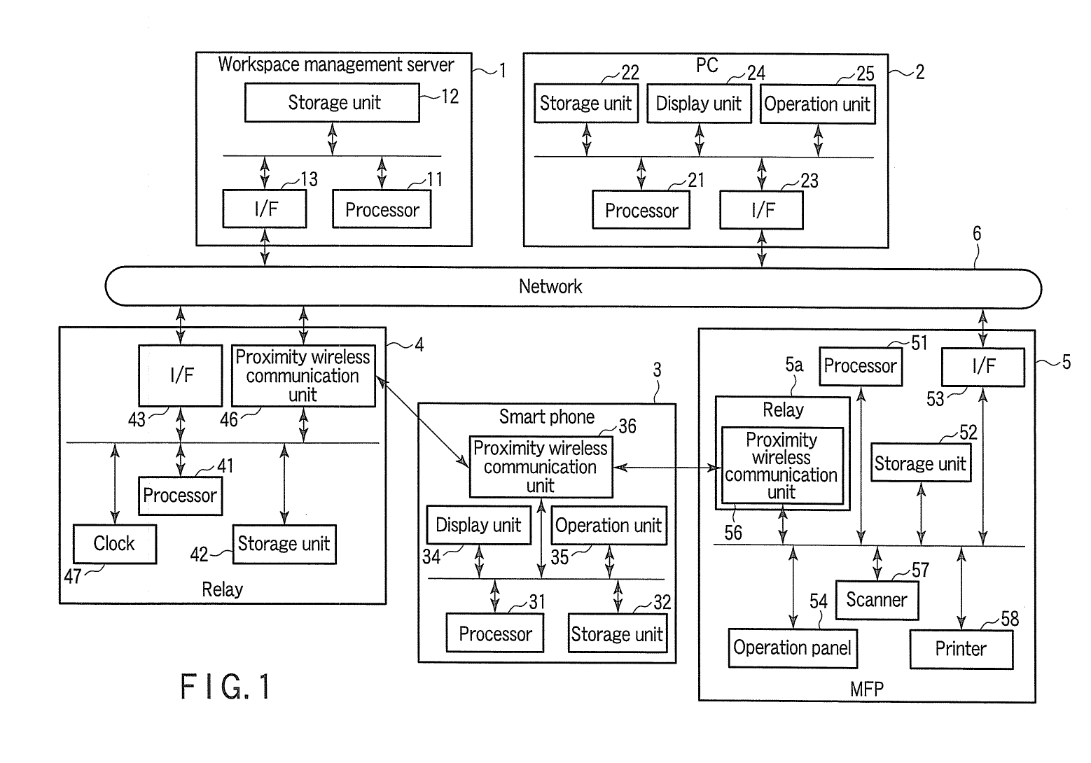

FIG. 1 is a diagram showing an exemplary hardware configuration of a document system which is a data sharing system.

The document system is a system in which a plurality of users shares data related to a business task such as document data. In the present embodiment, data that combines all kinds of information related to a certain business task together will be referred to as a workspace. For example, in the document system of the present embodiment, data that combines schedule information of a meeting as information related to the meeting with one or plural document files is managed as one workspace for the meeting. The present document system is a system that allows a plurality of users to share the workspaces by accessing them from a plurality of information devices.

In the configuration example shown in FIG. 1, the document system includes a workspace management server 1, a personal computer (PC) 2, a smart phone 3, a relay 4, a digital multifunction peripheral (MFP) 5, and a network 6. The MFP 5 includes a relay 5a that has a function similar to that of the relay 4.

The workspace management server 1 is a server that manages workspaces. The workspace management server 1 manages a plurality of workspaces shared by a plurality of users in a unified manner. The workspace management server 1 is connected to each device via the network 6. The workspace management server 1 can be accessed from each device connected to the network 6. As shown in FIG. 1, the workspace management server 1 includes hardware components such as, for example, a processor 11, a storage unit 12, and a network interface (I/F) 13.

In the workspace management server 1, the processor 11 executes various processing functions by executing a control program that is stored in the storage unit 12. The storage unit 12 functions as a data memory. The storage unit 12 has a database in which workspaces are stored. The storage unit 12 stores control programs and control data as well. The I/F 13 is an interface for communicating with each device via the network 6.

The PC 2 is an information processing device used by an individual user. The PC 2 has a function of connecting to the workspace management server 1 via the network 6. The PC 2 also has a function of viewing and editing workspaces by accessing the workspace management server 1. In the example shown in FIG. 1, the PC 2 has hardware components such as, for example, a processor 21, a storage unit 22, a network interface (I/F) 23, a display unit 24, and an operation unit 25.

In the PC 2, the processor 21 executes various processing functions by executing a control program stored in the storage unit 22. The storage unit 22 functions as a data memory. The storage unit 22 has a database in which workspaces are stored. The storage unit 22 stores control programs and control data as well. The I/F 23 is an interface for communicating with each device via the network 6. The display unit 24 displays document data such as an image or a text. The operation unit 25 is a hardware component for allowing a user to input an operation instruction. The operation unit 25 is configured, for example, by a keyboard, a pointing device, or a touch panel.

The smart phone 3 is a mobile device that is used by each user. The smart phone 3 has functions of storing document files, viewing data of the document files, editing data of the document files, storing history data such as a use history, or storing information related to the corresponding device and user. In the example shown in FIG. 1, the smart phone 3 has hardware components such as, for example, a processor 31, a storage unit 32, a display unit 34, an operation unit 35, and a proximity wireless (contactless) communication unit 36.

In the smart phone 3, the processor 31 executes various processing functions by executing a control program stored in the storage unit 32. The storage unit 32 functions as a data memory. The storage unit 32 stores workspaces or access history data for the workspaces. The storage unit 32 stores device information and user information as well. The storage unit 32 also stores control programs and control data. The display unit 34 displays the access history data for the workspaces and document data such as an image or a text included in the workspaces. The operation unit 35 is a hardware component for allowing a user to input an operation instruction. The operation unit 35 is configured, for example, by a keyboard, such as a ten-key numeric keypad, or a touch panel. The proximity wireless communication unit 36 is a communication unit for performing proximity wireless (contactless) communication.

The relay 4 is connected to the workspace management server 1 and the MFP 5 via the network 6. The relay 4 is capable of communicating with the workspace management server 1 or the MFP 5 via the network 6. Moreover, the relay 4 has a proximity wireless communication function to be described later. The relay 4 is capable of communicating with the smart phone 3 by the proximity wireless communication function. The relay 4 is installed at a specific place according to its operational form, such as a meeting room where communication with the smart phone 3 is necessary. In the example shown in FIG. 1, the relay 4 has hardware components such as, for example, a processor 41, a storage unit 42, a network interface (I/F) 43, a proximity wireless communication (contactless) unit 46, and a clock 47.

In the relay 4, the processor 41 executes various processing functions by executing a control program stored in the storage unit 42. The storage unit 42 functions as a data memory. The storage unit 42 has a database in which workspaces are stored. The storage unit 42 stores control programs and control data as well. Moreover, the storage unit 42 also stores information representing the place where the relay 4 is installed. The I/F 43 is an interface for communicating with each device via the network 6. The proximity wireless communication unit 46 is a communication unit for performing proximity wireless (contactless) communication. The proximity wireless communication unit 46 performs proximity wireless communication with the smart phone 3. The clock 47 measures the present time.

The digital multifunction peripheral (MFP) 5 has the functions of copier, printer, scanner, and image processor. For example, the MFP 5 is capable of printing document files, scanning a paper document to obtain digitalized data, and storing the document files. The MFP 5 is connected to the workspace management server 1 and the PC 2 via the network 6. The relay 5a of the MFP 5 is capable of performing proximity wireless communication (contactless) with the smart phone 3. In the example shown in FIG. 1, the MFP 5 has hardware components such as, for example, a processor 51, a storage unit 52, an I/F 53, an operation panel 54, a proximity wireless communication (contactless) unit 56, a scanner 57, and a printer 58.

In the MFP 5, the processor 51 executes various processing functions by executing a control program stored in the storage unit 52. The storage unit 52 functions as a data memory. The storage unit 52 stores image data and the like. The storage unit 52 stores control programs that the processor 51 executes and control data as well. The operation panel 54 is configured by a display unit and an operation unit. The operation panel 54 is configured, for example, by a keyboard, such as a ten-key numeric keypad, and a liquid-crystal display unit having a touch panel. The operation panel 54 displays an operation guide and receives operation instruction inputs from users.

The proximity wireless communication unit 56 is a hardware component for allowing users to input an operation instruction. The scanner 57 scans an image of an original document and converts the scanned image into image data. The scanner 57 generates document files by scanning a paper document to obtain digitalized data. The printer 58 prints images based on image data on paper. For example, the printer 58 prints image data based on a document file on paper.

Next, the functional units for using the workspaces in the document system having such a configuration will be described.

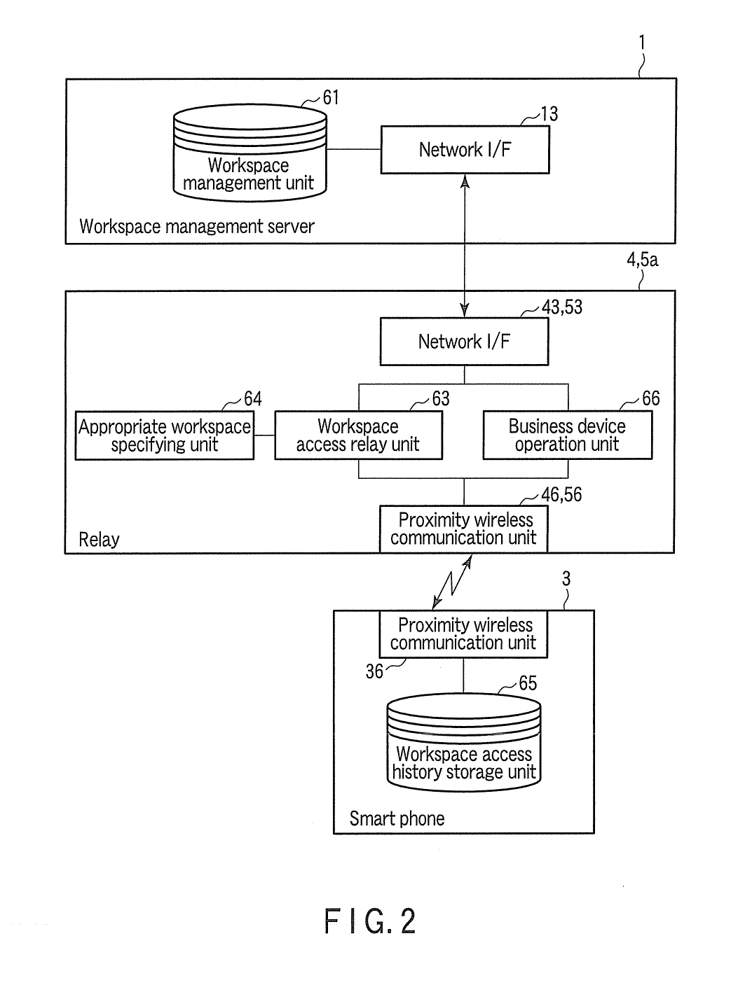

FIG. 2 is a diagram showing an exemplary functional configuration of the document system according to the first embodiment.

In FIG. 2, the document system of the first embodiment includes the following functional units for using the workspaces: network interfaces 13, 43, and 53, proximity wireless communication units 36, 46, and 56, a workspace management unit 61, a workspace access relay unit 63, an appropriate workspace specifying unit 64, a workspace access history storage unit 65, and a business device operation unit 66. The relay 4 does not have the business device operation unit 66.

As shown in FIG. 2, the network interface 13 and the workspace management unit 61 are functional units of the workspace management server 1, for example. The network interfaces 43 and 53, the proximity wireless communication units 46 and 56, the workspace access relay unit 63, the appropriate workspace specifying unit 64, and the business device operation unit 66 are functional units of the relay 4 (or the MFP 5 serving as the relay 5a). The proximity wireless communication unit 36 and the workspace access history storage unit 65 are functional units of the smart phone 3.

The network interfaces 13, 43, and 56 are interfaces for performing communication via the network 6. For example, the workspace management server 1 and the relay 4 are capable of performing network communication with the help of the network interfaces 13 and 43. Moreover, the workspace management server 1 and the MFP 5 serving as the relay 5a are capable of performing network communication with the intervention of the network interfaces 43 and 56.

The proximity wireless communication units 36, 46, and 56 are functional units that allow the smart phone 3 and the relay 4 or the smart phone 3 and the relay 5a to perform proximity wireless communication. For example, if the proximity wireless communication unit 36 of the smart phone 3 is brought close to the proximity wireless communication unit 46 of the relay 4, the smart phone 3 and the relay 4 start proximity wireless communication. If communication connection between the proximity wireless communication unit 36 of the smart phone 3 and the proximity wireless communication unit 46 of the relay 4 is established, the smart phone 3 and the relay 4 are able to communicate information therebetween by proximity wireless communication.

The proximity wireless communication units 36, 46, and 56 may employ various protocols as long as they perform radio communication at a short distance where a communication counterpart is definite. For example, the proximity wireless communication units 36, 46, and 56 may employ proximity wireless communication where a communication distance is within 3 cm or short-range wireless communication where a communication distance is within 10 to 20 cm. Moreover, the proximity wireless communication units 36, 46, and 56 may employ short-range wireless communication where a communication distance is within 1 to 10 m according to its operational form as long as a communication counterpart device is definite.

The workspace management unit 61 is a functional unit that stores and manages a plurality of workspaces in the workspace management server 1 in a unified manner. The workspace management unit 61 is also a functional unit that is implemented by the processor 11 of the workspace management server 1 using the storage unit 12. The workspace management unit 61 is implemented if the processor 11 of the workspace management server 1 executes a program. The workspace management unit 61 provides information of workspaces which are stored according to a request from each device connected to the workspace management server 1 via the network 6.

The workspace access relay unit 63 is a functional unit that is implemented if the processor 41 or 51 executes a program. For example, the workspace access relay unit 63 of the relay 4 allows the smart phone 3 that is wirelessly connected thereto with the help of the proximity wireless communication unit 36 to access the workspaces managed by the workspace management unit 61. If a workspace to be accessed by the smart phone 3 is designated, the workspace access relay unit 63 performs a relay operation of specifying the designated workspace from the workspaces managed by the workspace management unit 61 and allowing the smart phone 3 to access the specified workspace.

The appropriate workspace specifying unit 64 is a functional unit that is implemented if the processor 41 or 51 executes a program. The appropriate workspace specifying unit 64 selects a workspace that is appropriate for a predetermined condition from a plurality of workspaces managed by the workspace management unit 61. The appropriate workspace specifying unit 64 selects the workspace that is appropriate for unique information based on information (the unique information of the relay 4) representing the status if the relay 4 and the smart phone 3 are in a communicable state.

The unique information for selecting the workspace is information that corresponds to information related to a workspace. For example, if information representing schedules (execution places, date and time, and the like) related to the business task of each workspace is managed by the workspace management unit 61 as the information of each workspace, the following information can be used as the unique information for selecting the workspace: information representing the place where the relay 4 is installed and information representing the time (present time) if the relay 4 and the smart phone 3 are in the communicable state.

The workspace access history storage unit 65 is a functional unit that is implemented by the processor 31 of the smart phone 3 using the storage unit 32. The workspace access history storage unit 65 is implemented if the processor 31 of the smart phone 3 executes a program. The workspace access history storage unit 65 is a functional unit that stores information representing accessed workspaces as access history information if the smart phone 3 is connected to a workspace via the relay 4 with the help of the workspace access relay unit 63. The workspace access relay unit 63 is also capable of allowing the smart phone 3 to access, via the relay 4, the workspace that is designated by the access history information stored in the workspace access history storage unit 65. The access history information may be stored in the workspace management server 1 to be correlated with information that represents the smart phone 3.

The business device operation unit 66 is a functional unit that is implemented if the processor 51 executes a program. The business device operation unit 66 is a functional unit that gives operation instructions to the MFP 5 serving as a business device. For example, the business device operation unit 66 gives instructions related to the execution of printing, scanning, data transmission to the MFP 5.

Next, the function of the workspace management unit 61 will be described.

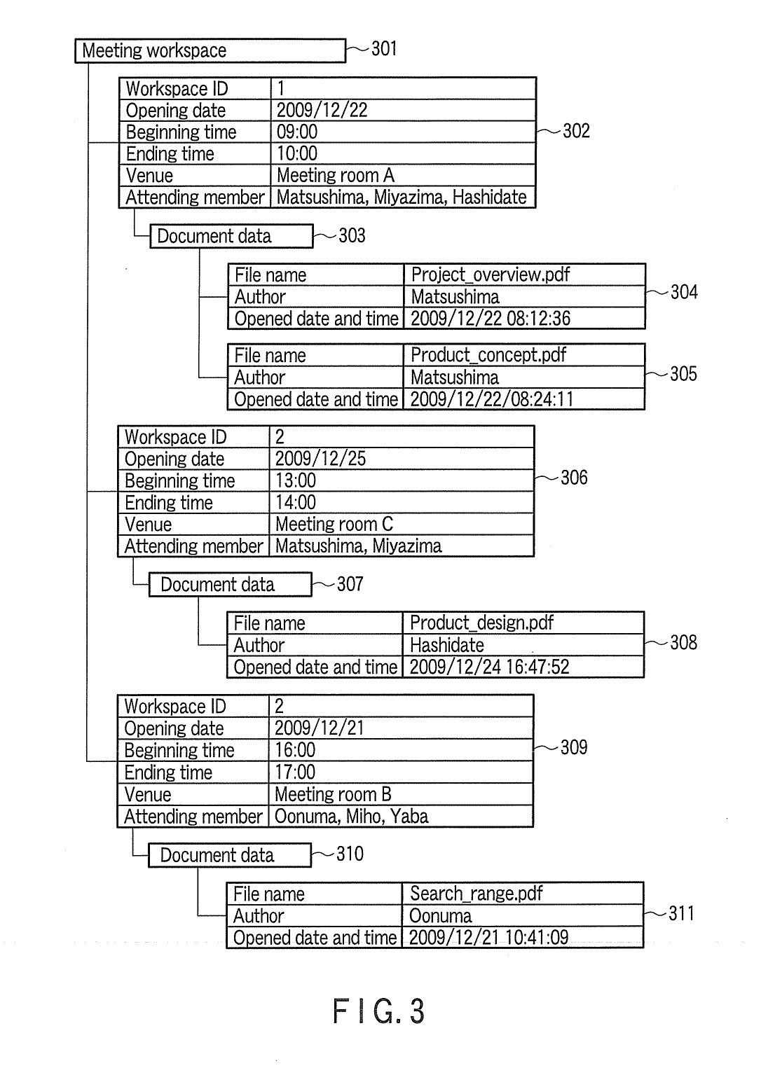

The workspace management unit 61 is a functional unit that, is provided to the workspace management server 1. The workspace management unit 61 is a functional unit that manages all kinds of information related to a certain business task as a workspace of the business task. FIG. 3 is a diagram showing an example of workspaces that are managed by the workspace management unit 61. In the example shown in FIG. 3, the workspace management unit 61 manages data that combine all kinds of information related to each meeting together for each meeting in a hierarchical structure as a workspace for the meeting.

In the example shown in FIG. 3, an item 301 that represents all the meeting workspaces is on the root folder. Items 302, 306, and 309 are present on the level immediately under the item 301 serving as the root folder of all the meeting workspaces. The items 302, 306, and 309 each represent an individual meeting workspace. In the example shown in FIG. 3, three meeting workspaces are stored as the items 302, 306, and 309. For example, in the items 302, 306, and 309, the following information is stored as the information on each meeting workspace: a workspace ID for uniquely identifying each workspace, the opening date and time of a meeting, the venue of a meeting, and information on members attending a meeting. Moreover, on the lower level of the items 302, 306, and 309, information that represents a document file serving as document data to be referenced by each workspace is stored.

For example, an item 303 serving as a folder that stores document data related to a workspace whose workspace ID is “1” is present on the level immediately under the item 302. Information that represents the two document files, namely items 304 and 305 is stored on the level immediately under the item 303. In the example shown in FIG. 3, the two document files represented by the items 304 and 305 are correlated to the workspace whose workspace ID is “1.” The following attribute information of the document data is stored in the items 304 and 305 as the information representing each document file: a file name, an author, and the opened date and time on the workspace management server 1. Moreover, an item 307 serving as a folder that stores document data related to a workspace whose workspace ID is “2” is present on the level immediately under the item 306. Information that represents one document file, namely an item 308 is stored on the level immediately under the item 307. Furthermore, an item 310 serving as a folder that stores document data related to a workspace whose workspace ID is “3” is present on the level immediately under the item 309. Information that represents one document file, namely an item 311 is stored on the level immediately under the item 310.

Next, the operation that the PC 2 performs on an accessed workspace will be described.

The workspaces that the workspace management server 1 manages with the help of the workspace management unit 61 can be viewed and edited on the PC 2. The workspace management unit 61 that is provided to the workspace management server 1 has a function of allowing a device on the network 6 to view and edit the workspaces. The function of viewing and editing the workspaces is provided, for example, by a Web-based application that is executed by the processor of the workspace management server 1. This function enables the PC 2 connected to the workspace management server 1 via the network 6 to view or edit the workspaces.

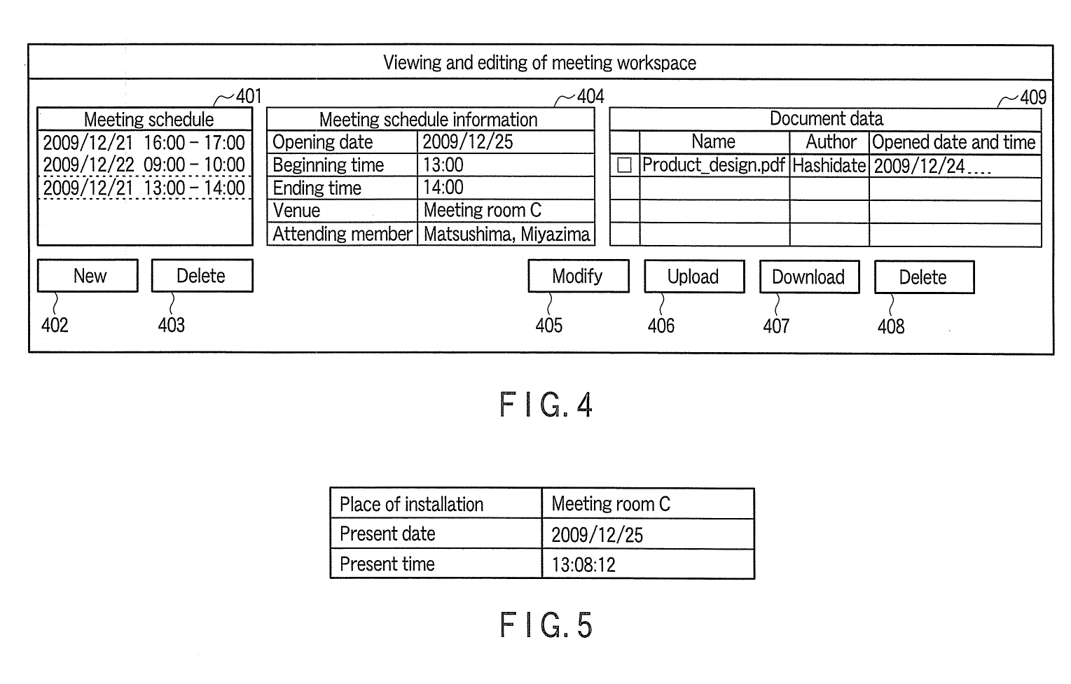

FIG. 4 is a diagram showing a display example of a workspace control screen on the PC 2.

The processor 21 of the PC 2 accesses the workspace management server 1 via the network 6 and acquires information related to a workspace from the workspace management server 1. Upon acquiring the information related to the workspace from the workspace management server 1, the processor 21 accesses a workspace designated by a user to display thereby a control screen of the workspace on the display unit 24. On the workspace control screen shown in FIG. 4, the following tables are displayed as the information related to the meeting workspace: a meeting list table 401, a meeting schedule table 404, and a document data table 409.

In the meeting list table 401, information representing all workspaces which are stored as the meeting workspace is displayed. In this example, it will be assumed that the three meeting workspaces shown in FIG. 3 are stored. Therefore, information representing the three meeting workspaces shown in FIG. 3 is displayed in the meeting list table 401. The user is able to select any meeting from a plurality of meetings displayed in the meeting list table 401 by operating a pointing device such as a mouse serving as the operation unit 25 of the PC 2. For example, if a displayed portion of one certain meeting is clicked, the processor 21 displays the workspace of the clicked meeting in a selected state.

If one meeting workspace is in the selected state, the processor 21 displays the schedule information of the meeting in a table 404 and also displays information representing the document file (which is stored in the meeting workspace) serving as the document data, which are stored in a correlated manner to the meeting in the selected state, in the table 409. The processor 21 displays the following information in the table 404 as the information representing the schedule of the meeting: date and time information (the opening date, the beginning time, and the ending time), location information (venue), and information representing attendees. For example, in the example shown in FIG. 4, the processor 21 displays the meeting schedule information of the item 309 shown in FIG. 3 in the table 404.

Moreover, the processor 21 displays the following information in the table 409 as the information representing the document file related to the meeting workspace in the selected state: a file name (name), an author, and the opened date and time. For example, in the example shown in FIG. 4, the processor 21 displays the information related to the document file of the item 308 shown in FIG. 3 in the table 409. If one document file displayed in the table 409 is clicked, the processor 21 displays the document file in a selected state.

Moreover, in the example of the workspace control screen shown in FIG. 4, the following buttons are displayed: a New button 402, a Delete button 403, a Modify button 405, an Upload button 406, a Download button 407, and a Delete button 408. For example, if the New button 402 is clicked, the processor 21 creates a new meeting workspace. If the Delete button 403 is clicked, the processor 21 deletes a workspace that is in the selected state in the table 401. Furthermore, if the Modify button 405 is clicked, the processor 21 modifies the contents of a workspace that is in the selected state in the table 401.

If the Upload button 406 is clicked, the processor 21 uploads a document file stored in the PC 2 to the workspace management server 1 to register thereby the document file to the workspace in the selected state. If the Download button 407 is clicked, the processor 21 downloads the document file in the selected state from the workspace management server 1. Furthermore, if the Delete button 408 is clicked, the processor 21 deletes the document file in the selected state.

Next, the function of the workspace access relay unit 63 will be described.

As described above, the workspace access relay unit 63 is a functional unit that is provided to the relay 4. The relay 4 has the proximity wireless communication unit 46 for performing proximity wireless communication with the smart phone 3. The relay 4 is installed at a place where a business task is executed or a place which a user passes through in order to execute a business task. For example, in an operational form in which workspaces for meetings are operated, the casing of the relay 4 having the processor 31, the storage unit 32, the I/F 33, the proximity wireless communication unit 36, and the clock 37 may be installed on the desk of each meeting room. In this case, the place of installation or the shape of the device is not particularly limited as long as the relay 4 has the above-described functional units. For example, in the operational form in which workspaces for meetings are operated, the relay 4 may be installed on an entrance wall of a meeting room or on the desk of each user.

If the smart phone 3 is brought close to the relay 4 having the workspace access relay unit 63, the proximity wireless communication unit 46 of the relay 4 starts proximity wireless communication with the proximity wireless communication unit 36 of the smart phone 3. If the wireless communication between the relay 4 and the smart phone 3 is established, the workspace access relay unit 63 of the relay 4 receives a workspace access request from the smart phone 3. If an access request for a specific workspace is received from the smart phone 3, the workspace access relay unit 63 performs a relay operation of allowing the smart phone 3 to access a designated workspace. For example, the workspace access relay unit 63 acquires information of a workspace, which the smart phone 3 is allowed to access, from the workspace management unit 61 via the network 6 and sends the acquired workspace information to the smart phone 3. The smart phone 3 displays the workspace information acquired via the relay 4 on the display unit 34.

Moreover, the workspace access relay unit 63 receives an instruction from the smart phone 3 to download a document file related to the workspace. If it is instructed by the smart phone 3 to download the document file related to the workspace, the workspace access relay unit 63 acquires the document file that it is instructed to download from the workspace management unit 61 of the workspace management server 1 and sends the acquired document file to the smart phone 3.

Furthermore, the workspace access relay unit 63 receives an instruction to register (upload) the document file stored in the smart phone 3 as document data related to the workspace. If it is instructed by the smart phone 3 to upload the document file related to the workspace, the workspace access relay unit 63 sends the document file that it is instructed to upload to the workspace management unit 61 of the workspace management server 1 and sends information representing the processing results on the uploading of the document file to the smart phone 3.

Next, the function of the appropriate workspace specifying unit 64 will be described.

The appropriate workspace specifying unit 64 is a functional unit that is provided to the relay 4. As described above, the relay 4 is installed at each place where a business task is executed. The information representing the place where the relay 4 is installed is stored in the appropriate workspace specifying unit 64 as the unique information of the relay 4. Moreover, the present date and time is measured by the clock 47. The appropriate workspace specifying unit 64 of the relay 4 manages the following information as the unique information of the relay 4: the information representing the place where the relay 4 is installed and the information representing the present time.

FIG. 5 is a diagram showing an example of the information that is managed as the unique information of the relay 4. In the example shown in FIG. 5, “Meeting Room C” where the relay 4 is installed is stored as the place of installation, and “2009/12/25” which is the present date and “13:08:12” which is the present time are stored as the date and time information.

If proximity wireless communication between the relay 4 and the smart phone 3 is established, the appropriate workspace specifying unit 64 references the unique information of the relay 4 and specifies a workspace that is appropriate for the unique information of the relay 4 from the workspace management unit 61. In this embodiment, the workspace appropriate for the unique information of the relay 4 will be referred to as an appropriate workspace. For example, in the case of workspaces for meetings, a workspace of a meeting which is presently held at the place where the relay 4 is installed is the appropriate workspace.

The appropriate workspace specifying unit 64 specifies the appropriate workspace by comparing the unique information of the relay 4 with the schedule information of each workspace managed by the workspace management unit 61. For example, if the unique information of the relay 4 shows that the place of installation is “Meeting Room C” and the date and time information is “2009/12/25 13:08:12,” the appropriate workspace specifying unit 64 selects a workspace of a meeting, which is held in Meeting Room C on 2009/12/25 13:08:12, as an appropriate workspace. In the example shown in FIG. 3, the meeting workspace shown in the item 306 is the workspace that has schedule information appropriate for the unique information. Therefore, the appropriate workspace specifying unit 64 determines the meeting workspace of the item 306 from the workspace management unit 61 as the appropriate workspace.

Next, the relay operation wherein the relay 4 allows the smart phone 3 to access a workspace will be described.

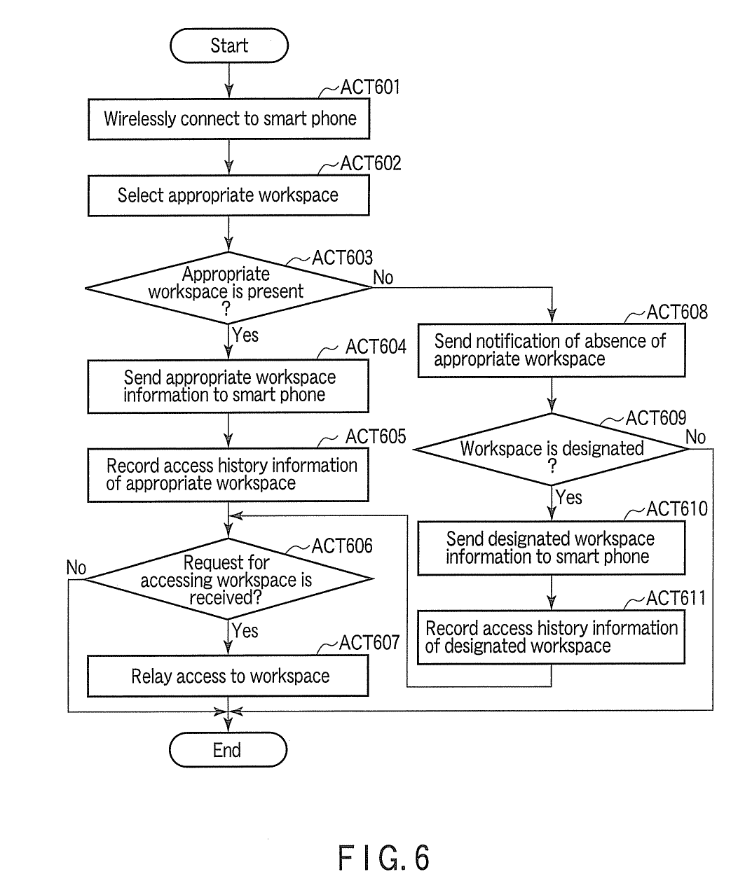

FIG. 6 is a flowchart showing the relay operation wherein the relay 4 allows the smart phone 3 to access a workspace.

First, if a user brings the smart phone 3 close to the relay 4, the processor 41 performs a communication connection operation for establishing proximity wireless communication between the proximity wireless communication unit 46 and the proximity wireless communication unit 36 of the smart phone 3 (ACT 601). For example, the relay 4 establishes communication connection between the smart phone 3 and the relay 4 by causing the proximity wireless communication unit 46 to respond to a response request wirelessly transmitted from the proximity wireless communication unit 36 of the smart phone 3.

If the communication connection with the smart phone 3 is established, the processor 41 causes the appropriate workspace specifying unit 64 to select an appropriate workspace appropriate for the unique information of the relay 4 from the workspaces managed by the workspace management unit 61 (ACT 602). For example, the processor 41 selects the appropriate workspace by comparing the unique information of the relay 4 including the place where the relay 4 is installed and the present date and time measured by the clock 47 with the schedule information of the workspaces managed by the workspace management unit 61.

The processor 41 determines whether or not there is an appropriate workspace that is appropriate for the unique information of the relay 4 (ACT 603). If there is the appropriate workspace that is appropriate for the unique information of the relay 4 (ACT 603: YES), the processor 41 sends information representing the appropriate workspace to the smart phone 3 (ACT 604).

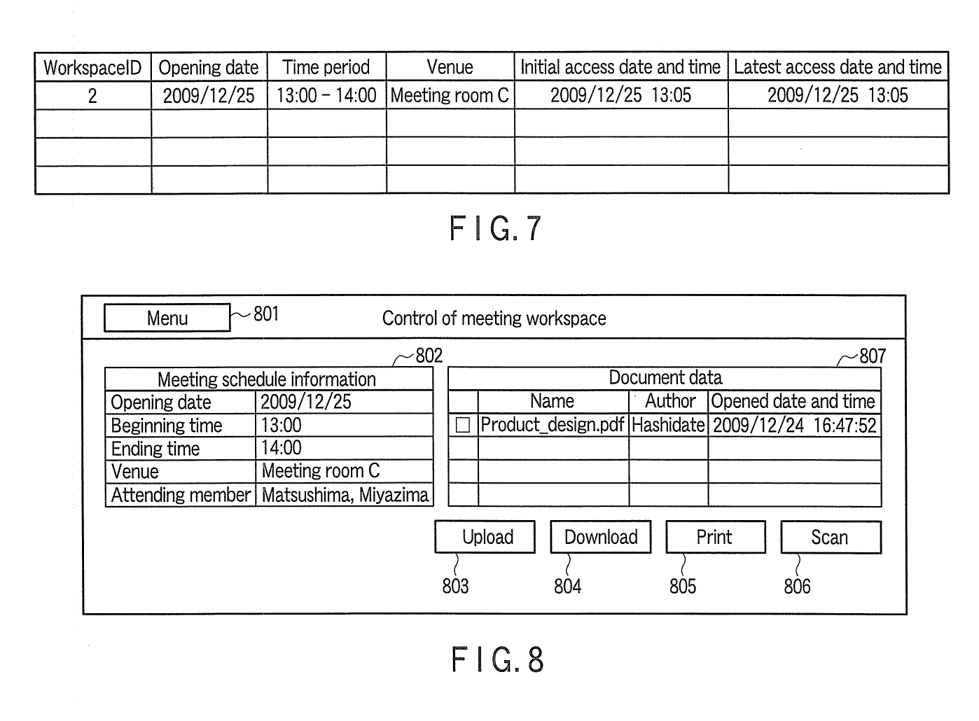

Moreover, if the information representing the appropriate workspace is sent, the processor 41 causes the workspace access history storage unit 65 of the smart phone 3 to store access history information representing that the appropriate workspace was accessed by the smart phone 3 (ACT 605). FIG. 7 is a diagram showing an example of the access history information that is stored in the workspace access history storage unit 65. In the example shown in FIG. 7, the following information is stored as the access history information representing the history of an access to the workspace: a workspace ID, an opening date, a time period, the venue, the initial connection date and time, and the latest connection date and time. The workspace ID is information for identifying the workspace. The opening date, the time period, and the venue are the schedule information of the workspace. The initial access date and time is the date and time if an initial access to the workspace was made, and the latest access date and time is the date and time if the latest access to the workspace was made.

After the information representing the appropriate workspace appropriate for the unique information of the relay 4 is sent, the processor 41 determines whether or not there is an access request for the appropriate workspace from the smart phone 3 (ACT 606). If there is an access request for the appropriate workspace from the smart phone 3 (ACT 606: NO), the processor 41 performs a relay operation of allowing the smart phone 3 to access the appropriate workspace (ACT 607).

Moreover, if there is no access request for the appropriate workspace appropriate for the unique information of the relay 4 (ACT 603: NO), the processor 41 sends a notification to the smart phone 3 informing that there is no appropriate workspace (ACT 608). If the notification informing that there is no appropriate workspace is received, the processor 41 receives an access request for a workspace that is designated based on the access history information stored in the workspace access history storage unit 65 of the smart phone 3. Moreover, even if the information representing the appropriate workspace is sent, the processor 41 receives an access request for a workspace that is designated based on the access history information stored in the workspace access history storage unit 65 of the smart phone 3.

The processor 41 determines whether or not an access request for the workspace designated based on the access history information is received from the smart phone 3 (ACT 609). If the access request for the workspace designated based on the access history information is received from the smart phone 3 (ACT 609: YES), the processor 41 performs a relay operation of allowing the smart phone 3 to access the designated workspace (ACT 610). If the smart phone 3 is allowed to access the designated workspace, the processor 41 causes the workspace access history storage unit 65 of the smart phone 3 to record access history information representing the history of an access to the designated workspace (ACT 611).

Moreover, if there is no appropriate workspace and there is no designation of a workspace based on the access history information (ACT 609: NO), the processor 41 stops the relay operation of allowing the smart phone 3 to access the workspace.

As described above, if the smart phone 3 is brought close thereto, the relay 4 performs the relay operation of selecting an appropriate workspace appropriate for the present status (the place where it is installed and the present date and time), informing the smart phone 3 of the selected appropriate workspace, and allowing the smart phone 3 to access the appropriate workspace in response to an access request. In this way, the user is able to acquire easily a workspace appropriate for the present status (the present location and date and time) and display the information of the workspace on the smart phone 3 just by bringing the smart phone 3 close to the relay 4.

Next, the operation of the smart phone 3 corresponding to the operation of the relay 4 will be described.

As described above, if the user brings the smart phone 3 close to the relay 4, the smart phone 3 acquires an appropriate workspace with the help of the relay 4. Upon acquiring the information of the workspace, the processor 31 of the smart phone 3 displays the received workspace information on the display unit 34.

FIG. 8 is a diagram showing an example of the workspace information that is displayed on the display unit 34.

FIG. 8 shows a display example in which the appropriate workspace acquired via the relay 4 is a workspace for a meeting. In the display example shown in FIG. 8, the following buttons and tables are displayed: a Menu button 801, a schedule information table 802, an Upload button 803, a Download button 804, a Print button 805, a Scan button 806, and a document data table 807. In the display example shown in FIG. 8, the schedule information table 802 and the document data table 807 are displayed as the information representing the contents of a meeting serving as a business task corresponding to the workspace.

In the schedule information table 802, the following information is displayed as the information representing the schedule of the meeting serving as the business task corresponding to the workspace: date and time information (the opening date and the beginning and ending time), location information (venue), and attendants. In the document data table 807, the following information is displayed as the information representing the document data related to the meeting serving as the business task corresponding to the workspace: a file name (name), an author, and the opened date and time. For example, in the display example shown in FIG. 8, the document files displayed in the document data table 807 are selected by an operation of the operation unit 35.

Moreover, in the display example shown in FIG. 8, the user is able to perform various operations by clicking on the Menu button 801, the Upload button 803, the Download button 804, the Print button 805, and the Scan button 806. For example, if the Menu button 801 is clicked, the processor 21 displays a menu screen concerning the control of a workspace. For example, if the Menu button 801 is clicked, the control screen for selecting a workspace from the access history information is changed from the menu screen.

If the Upload button 803 is clicked, the processor 31 sends a request to the relay 4 to register a document file stored in the smart phone 3 to the workspace in the selected state. In this case, the document file is uploaded to the workspace management server 1 via the relay 4 and is thereby registered to the workspace in the selected state. If the Download button 804 is clicked, the processor 31 sends a request to the relay 4 to download the document file in the selected state. In this case, the document file is downloaded from the workspace management server 1 via the relay 4.

Moreover, the Print button 805 and the Scan button 806 are buttons for activating operations executed by the business device operation unit 66 of the relays 4 and 5a. In this embodiment, it will be assumed that the Print button 805 and the Scan button 806 are displayed if the relay 5a of the digital multifunction peripheral (MFP) 5 serving as the business device and the smart phone 3 are connected for communication. If the Print button 805 is clicked, the processor 31 sends a request to the relay 5a to cause the MFP 5 to print the document data of the workspace in the selected state. Moreover, if the Scan button 806 is clicked, the processor 31 sends a request to the relay 5a to cause the MFP 5 to read the image of an original document and register the image to a workspace.

If there is a plurality of appropriate workspaces, the processor 31 may display all kinds of information related to the workspaces in a list form. In this case, the processor 31 may display one workspace that the user selects from a list of the plurality of appropriate workspaces on the screen such as shown in FIG. 8.

Next, the flow of processing on the smart phone 3 according to the first embodiment will be described.

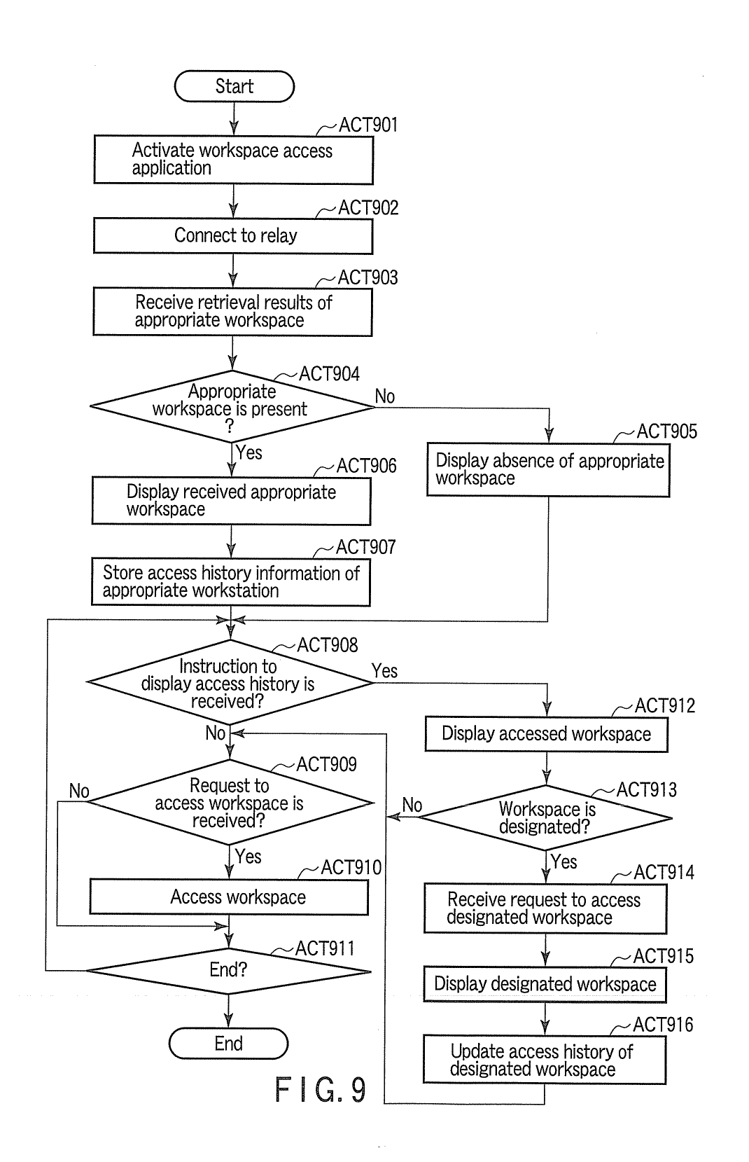

FIG. 9 is a flowchart showing a processing example of the smart phone 3 according to the first embodiment.

For example, it will be assumed that a workspace access application that can be executed by the processor 31 for accessing workspaces is installed in the smart phone 3. If the user operates the operation unit 35 of the smart phone 3 to issue an instruction for activating the workspace access application, the processor 31 activates the workspace access application (ACT 901).

If the workspace access application is activated, the processor 31 causes the proximity wireless communication unit 36 to output a response request for wireless communication with respect to devices at the proximity. If the proximity wireless communication unit 46 of the relay 4 responds to the response request, the smart phone 3 establishes communication connection with the relay 4 (ACT 902). After the communication connection with the relay 4 is established, the smart phone 3 receives information representing the selection results on the appropriate workspace from the relay 4 (ACT 903).

The processor 31 determines whether or not a message informing that there is no appropriate workspace is received from the relay 4 as the selection results of the appropriate workspace (ACT 904). If the message informing that there is no appropriate workspace is received from the relay 4 as the selection results of the appropriate workspace (ACT 904: NO), the processor 31 of the smart phone 3 displays a message that there is no appropriate workspace on the display unit 34 (ACT 905). In this case, the processor 31 of the smart phone 3 may display a guide screen on the display unit 34, guiding users to select a workspace based on the access history information stored in the workspace access history storage unit 65.

If information of the appropriate workspace is received from the relay 4 (ACT 904: YES), the processor 31 displays the information representing the appropriate workspace on the display unit 34 (ACT 906) as shown in FIG. 8. In addition, if the information of the appropriate workspace is received from the relay 4, the processor 31 stores access history information representing that an access to the appropriate workspace was already made in the workspace access history storage unit 65 (ACT 907).

In the state where the information of the appropriate workspace is displayed on the display unit 34 or the message that there is no appropriate workspace is displayed on the display unit 34, the processor 31 receives an instruction to display the access history information. For example, if the information of the appropriate workspace is displayed as shown in FIG. 8, it may be instructed to display the access history information on the menu screen which is displayed if the Menu button 801 is clicked. Moreover, if the message that there is no appropriate workspace is displayed, a select button for an instruction to display the access history information may be displayed.

The processor 31 determines whether or not an instruction to display the access history information is input (ACT 908). If the instruction to display the access history information is not input (ACT 908: NO), the processor 31 determines whether or not there is an instruction requesting an access to the workspace being displayed (ACT 909). If there is the instruction requesting an access to the workspace being displayed (ACT 909: YES), the processor 31 accesses the workspace managed by the workspace management server 1 via the relay 4 (ACT 910). For example, if there is an access request in the state where the appropriate workspace is displayed, the processor 31 performs an operation of accessing the appropriate workspace. For example, the operation of downloading or uploading the document data of the workspace being displayed is executed in response to the user's instruction on the display screen such as shown in FIG. 8.

If the document file stored in the workspace is downloaded to the smart phone 3, the user clicks on the Download button 804 while selecting one document file from the document data table 807 shown in FIG. 8. Then, the processor 31 of the smart phone 3 sends an instruction to the relay 4 to download the selected document file. Upon receiving the instruction, the relay 4 acquires the requested document file from the workspace management unit 61 of the workspace management server 1 with the help of the workspace access relay unit 63 and transmits the document file to the smart phone 3. In this way, the smart phone 3 is able to acquire the selected document file from the workspace management server 1 via the relay 4 and view the acquired document file.

Moreover, if the document file stored in the smart phone 3 is uploaded to the workspace, the user clicks on the Upload button 803. Then, the processor 31 of the smart phone 3 displays a dialog on the display unit 34, showing document files stored in the storage unit 32. The user selects a document file to upload from the displayed document files. Then, the processor 31 of the smart phone 3 sends an instruction to the relay 4 to register the selected document file to the workspace being displayed. Upon receiving the instruction, the relay 4 registers the document file received from the smart phone 3 to the workspace managed by the workspace management server 1 with the help of the workspace access relay unit 63.

If the instruction to display the access history information is input (ACT 908: YES), the processor 31 displays a list of accessed workspaces (ACT 912). The accessed workspaces are stored in the workspace access history storage unit 65. Therefore, upon receiving the instruction to display the access history information, the processor 31 displays information representing the accessed workspaces stored in the workspace access history storage unit 65 on the display unit 34 in a list form.

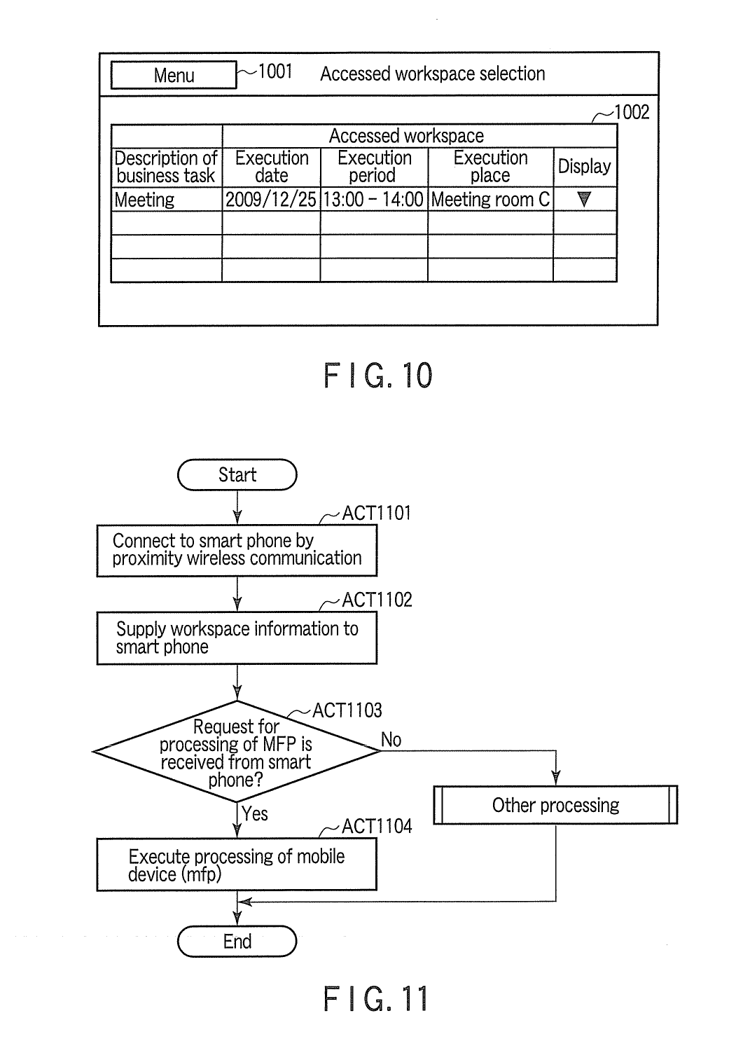

FIG. 10 is a diagram showing a display example of the accessed workspaces. In the display example shown in FIG. 10, a Menu button 1001 and a workspace list 1002 are displayed. In the workspace list 1002, the following information is displayed as the information representing each accessed workspace: description of a business task, the execution date, the execution time, and the execution place. The workspaces displayed in the workspace list 1002 can be selected by using the operation unit 35. For example, in the display example shown in FIG. 10, an instruction to display the workspace can be issued by selecting an inverted triangular mark on the rightmost column on the row of the information representing each workspace.

The processor 31 determines whether or not there is an end instruction from the user (ACT 911). If there is an end instruction from the user (ACT 911: YES), the processor 31 ends processing on the workspaces. Moreover, if there is no instruction requesting an access to the workspaces being displayed (ACT 909: NO), the process also ends.

The processor 31 determines whether or not one workspace is selected by the user in the state where a list of the accessed workspaces is displayed (ACT 913). If one workspace is selected by the user in the state where a list of the accessed workspaces is displayed (ACT 913: YES), the processor 31 sends an access request for the selected workspace to the relay 4 (ACT 914). For example, the processor 31 determines the workspace ID of the accessed workspace selected by the user from the access history information and sends an instruction to the relay 4 to access the workspace corresponding to the workspace ID. The relay 4 acquires the workspace corresponding to the accessed workspace ID requested by the smart phone 3 from the workspace management unit 61 of the workspace management server 1 with the help of the workspace access relay unit 63. The relay 4 transmits the information of the workspace acquired from the workspace management server 1 to the smart phone 3. In this way, the smart phone 3 is able to acquire the information of the accessed workspace being selected.

If the information of the accessed workspace selected by the user is received from the relay 4, the processor 31 of the smart phone 3 displays the received workspace information on the display unit 34 (ACT 915). For example, the processor 31 displays the information of the accessed workspace on the display unit 34 in the display format such as shown in FIG. 8. In addition, even if the information of the accessed workspace is received, the processor 31 updates the access history information of the designated workspace (ACT 916). However, if information such as the latest date and time of an access made to the workspace or the number of accesses is not stored in the access history information, the operation of ACT 915 may be omitted.

As described above, the smart phone 3 is able to access a workspace again that it accessed in the past with the help of the access history information stored in the workspace access history storage unit 65. In other words, the smart phone 3 cannot access a workspace for a business task that it has not accessed in the past. That is to say, only users who attended the business task (e.g., meetings) and accessed the workspace in the past with the smart phone 3 are able to access the accessed workspace with the help of the access history information, whereas users who had not attended the business task such as the meetings are unable to access the workspace of the business task.

Next, the function of the business device operation unit 66 will be described.

The business device operation unit 66 is a functional unit that is implemented if the processor 51 executes a program. Here, the relay 5a has the same function as the relay 4 and includes the business device operation unit 66. The business device operation unit 66 is a functional unit that operates each unit of the MFP 5 serving as a business device according to an instruction from the smart phone 3. In other words, the processor 51 is operated according to the instruction received from the smart phone 3 by proximity wireless communication. In this embodiment, a processing example in which the Print button 805 or the Scan button 806 is selected in the display example shown in FIG. 8 will be described.

FIG. 11 is a flowchart showing the functions of the business device operation unit 66.

First, if the user brings the smart phone 3 close to the proximity wireless communication unit 56 of the relay 5a, the processor 51 performs a communication connection operation for establishing proximity wireless communication between the proximity wireless communication unit 56 and the proximity wireless communication unit 36 of the smart phone 3. For example, the relay 5a establishes communication connection between the smart phone 3 and the MFP 5 by causing the proximity wireless communication unit 56 of the MFP 5 to respond to a response request wirelessly transmitted from the proximity wireless communication unit 36 of the smart phone 3 (ACT 1101).

If the communication connection with the smart phone 3 is established, the processor 51 performs the same processing as that of ACTS 601 to 607. In this way, the smart phone 3 is supplied with the information of the appropriate workspace or the accessed workspace selected by the user (ACT 1102). Upon acquiring the workspace information, the smart phone 3 displays the workspace information in the display format such as shown in FIG. 8. In this state, the MFP 5 is able to execute processing such as printing or scanning in response to the instruction from the smart phone 3 by the function of the business device operation unit 66 of the relay 5a. That is to say, if there is a request from the smart phone 3 to perform an operation on the workspace, the processor 51 determines whether or not the operation is an operation that should be executed on the workspace with the MFP 5 serving as the business device (ACT 1103). For example, the operation of printing the document file of a workspace or registering a scanned file to the workspace is determined to be such an operation that should be executed with the MFP 5 serving as the business device. If it is determined that there is a request to perform the operation that should be executed with the MFP 5 serving as the business device (ACT 1103: YES), the processor 51 executes the operation requested from the smart phone 3 with the help of the business device operation unit 66 (ACT 1104).

For example, it will be assumed that the user clicks on the Print button 805 in the state where one document file is selected on the document data table 807 in the display example shown in FIG. 8. Then, the processor 31 of the smart phone 3 sends a print instruction to the relay 5a to print a document file in the selected state of the workspace being presently displayed by proximity wireless communication of the proximity wireless communication unit 36. The relay 5a receives the print instruction to print the document file by proximity wireless communication of the proximity wireless communication unit 56.

Upon receiving the print instruction to print the document file of the workspace, the processor 51 acquires the selected document file from the workspace management unit 61 of the workspace management server 1 with the help of the workspace access relay unit 63 of the relay 5a. Upon acquiring the document file, the processor 51 converts the acquired document file into print data with the help of the business device operation unit 66 of the relay 5a and prints the data with the printer 58. In the case of a connection form in which the relay 5a and the MFP 5 are connected via a network, the relay 5a may cause the MFP 5 to print the document file with the help of the business device operation unit 66 by using a Web-based printing service that the MFP 5 has.

Moreover, it will be assumed that the user clicks on the scan button 806 in the display example shown in FIG. 8. Then, the processor 31 of the smart phone 3 sends an instruction to the relay 5a to register scanned image data of an original paper document to the workspace being presently displayed as the document file by proximity wireless communication of the proximity wireless communication unit 36. If the instruction to register the scanned image data to the workspace by proximity wireless communication of the proximity wireless communication unit 56 is received, the processor 51 scans a paper document (original document) using the scanner 57 and registers the scanned image data to the workspace as the document file with the help of the business device operation unit 66 of the relay 5a.

If it is determined that there is no request to perform the operation that should be executed with the MFP 5 serving as the business device (ACT 1103: NO), the processor 51 performs processing different from that of ACT 1104.

As described above, in the document system according to the first embodiment, if the user who is attending a business task (e.g., meetings) brings the smart phone 3 close to the relay 4, the smart phone 3 accesses an appropriate workspace with the help of the relay 4. The smart phone 3 that accesses the appropriate workspace stores the access history information of the access to the appropriate workspace (the workspace of a business task that the user is attending) in the workspace access history storage unit 65. After the business task (meeting) ends, the user is able to access easily the workspace of the attended business task with the help of the access history information to print thereby the document file stored in the workspace and register the scanned file of a paper document to the workspace.

While in the above embodiment, the processing of the relay 5a was performed by a main processor of the MFP 5, the processing may be performed by an internal processor of the relay 5a.

Next, the second embodiment will be described.

The second embodiment is a modification of the first embodiment. The document system according to the second embodiment can be implemented by the same hardware configuration as the first embodiment shown in FIG. 1. Therefore, detailed description of the hardware configuration of the document system according to the second embodiment will be omitted.

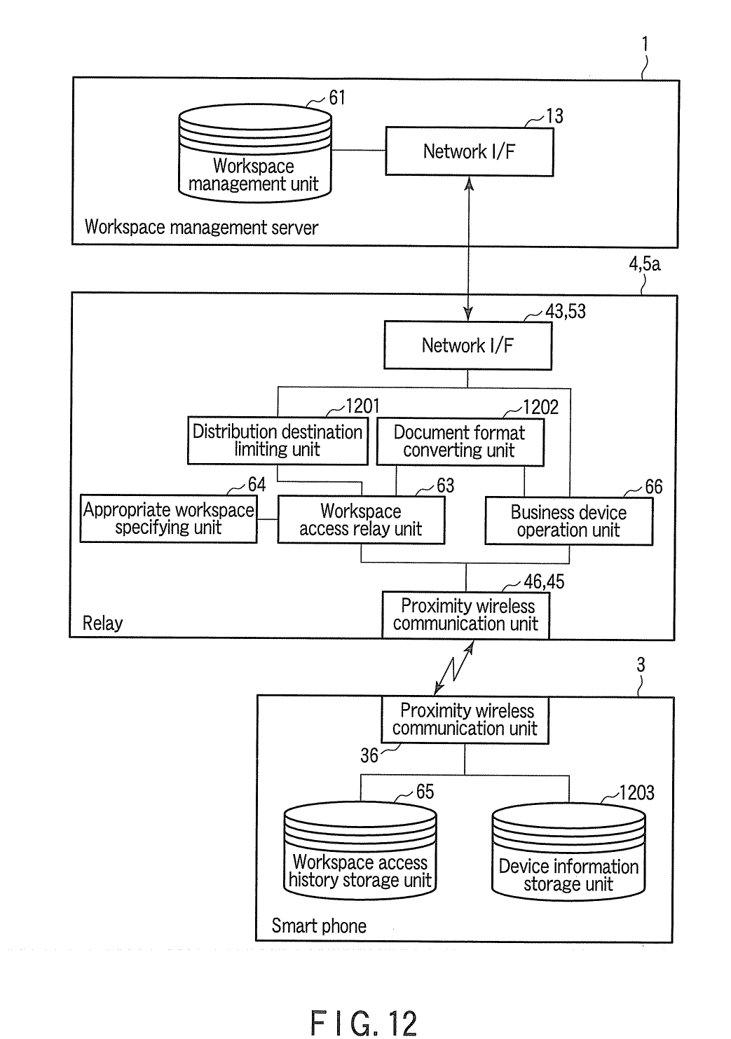

FIG. 12 is a diagram showing an exemplary functional configuration of the document system according to the second embodiment.

As shown in FIG. 12, the document system of the second embodiment includes network interfaces 13, 43, and 53, proximity wireless communication units 36, 46, and 56, a workspace management unit 61, a workspace access relay unit 63, an appropriate workspace specifying unit 64, a workspace access history storage unit 65, a business device operation unit 66, a distribution destination limiting unit 1201, a document format converting unit 1202, and a mobile device information storage unit 1203.

The network interfaces 13, 43, and 53, the proximity wireless communication units 36, 46, and 56, the workspace management unit 61, the workspace access relay unit 63, the appropriate workspace specifying unit 64, the workspace access history storage unit 65, and the business device operation unit 66 are the same functional units as the functional units described in the first embodiment. That is, the document system of the second embodiment includes the distribution destination limiting unit 1201, the document format converting unit 1202, and the mobile device information storage unit 1203 in addition to the functional units described in the first embodiment.

The distribution destination limiting unit 1201 is a functional unit that is provided to the relay 4 or 5a. The distribution destination limiting unit 1201 is a functional unit that is implemented if the processor 41 or 51 executes a program. The distribution destination limiting unit 1201 is a functional unit that limits the distribution destination (the distribution destination user) of the information (e.g., a document file) stored in each workspace. If a document file of a workspace managed by the workspace management unit 61 is transmitted (distributed), the distribution destination limiting unit 1201 limits the transmission destination (the distribution destination user) according to an acquisition right that is set in the document file.

The document format converting unit 1202 is a functional unit that is provided to the relay 4 or 5a. The document format converting unit 1202 is a functional unit that is implemented if the processor 41 or 51 executes a program. The document format converting unit 1202 converts the document file into data corresponding to a distribution destination device. For example, if a document file stored in a workspace is transmitted (distributed) to the smart phone 3, the document format converting unit 1202 converts the data of the document file according to a processing capability (e.g., the displaying capability of the display unit 34) which is described in the device information of the smart phone 3.

The mobile device information storage unit 1203 is a functional unit that is implemented by the processor 31 of the smart phone 3 using the storage unit 32. The mobile device information storage unit 1203 is implemented if the processor 31 of the smart phone 3 executes a program. The mobile device information storage unit 1203 stores the following information as the mobile device information: the device information of the smart phone 3 itself and the user information of the user of the smart phone 3. The device information includes information representing the device configuration and the processing capability of the smart phone 3 itself. For example, the displaying capability of the display unit 34 is included in the device information. Moreover, in the user information, a user name and the like are stored as information representing the owner (user) of the smart phone 3.

In the document system according to the second embodiment, the distribution destination user (the user to whom the distribution is allowed) is set for each document file of the workspaces managed by the workspace management unit 61. Therefore, the document files of each workspace are distributed only to the smart phone 3 of the user who is set as the distribution destination.

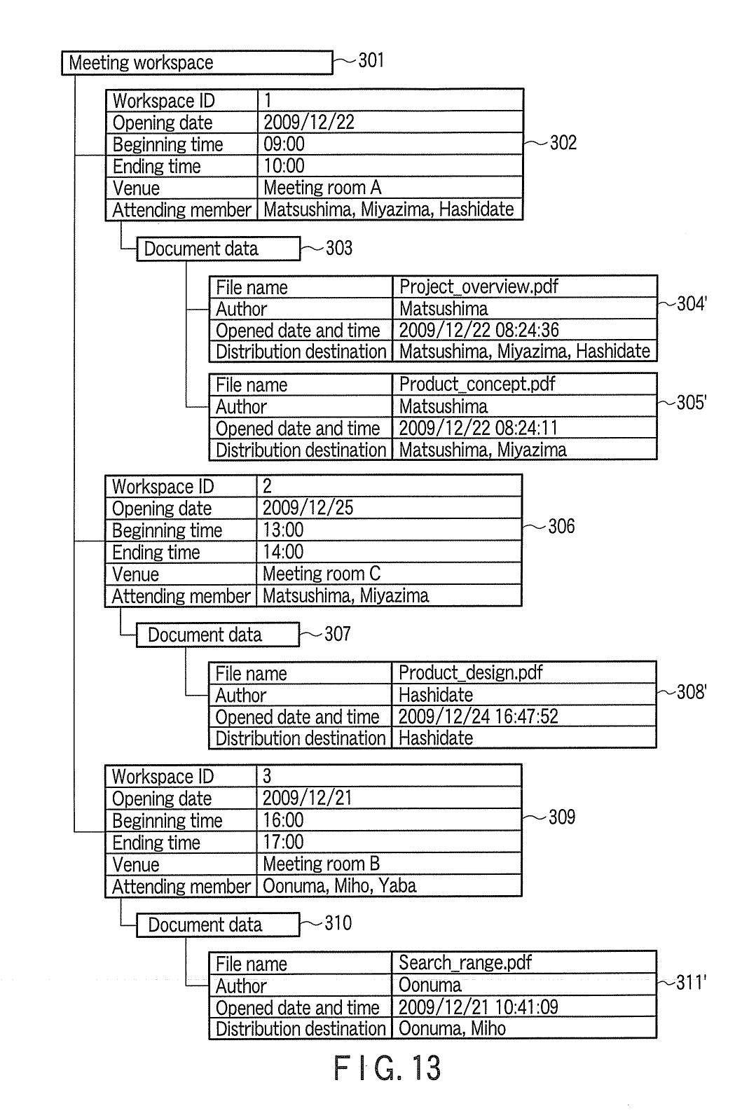

FIG. 13 is a diagram showing an example of workspaces that are managed by the workspace management unit 61 in the document system according to the second embodiment.

In the example shown in FIG. 13, information representing the distribution destination is attached to the document files of each of the workspaces shown in FIG. 3 described in the first embodiment. Therefore, in FIG. 13, the same data as those in FIG. 3 are depicted at the same locations and referenced by the same reference numbers, and detailed description thereof will be omitted.

For example, two document files that are shown in items 304′ and 305′ are stored in the meeting workspace of the item 302. Here, in the document file (Project_Overview.pdf) of the item 304′, three persons (“Matsushima,” “Miyazima,” and “Hashidate”) are set as the distribution destination user. On the other hand, in the document file (Product_Concept.pdf) of the item 305′, two persons (“Matsushima” and “Miyazima”) are set as the distribution destination user. Therefore, the two persons (“Matsushima” and “Miyazima”) are allowed to acquire the two document files; however, the other person (“Hashidate”) is not allowed to acquire the document file of the item 305′ but is only allowed to acquire the document file of the item 304′.

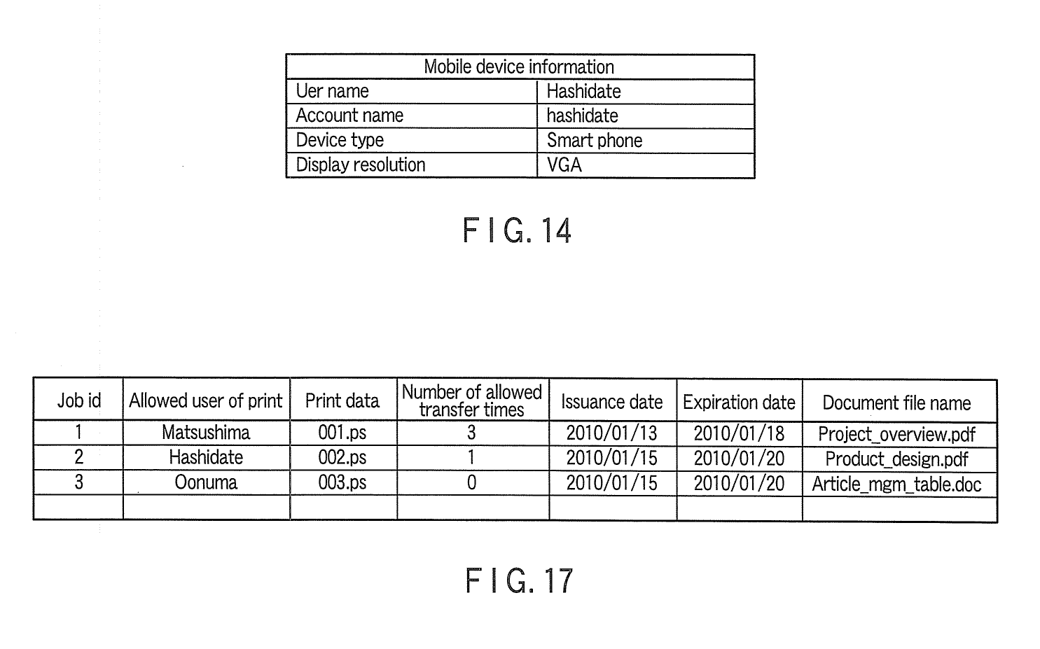

The smart phone 3 stores the following information as the mobile device information with the help of the mobile device information storage unit 1203: the device information of the smart phone 3 itself and the user information of the user of the smart phone 3. FIG. 14 is a diagram showing an example of information that is stored in the mobile device information storage unit 1203. In the example shown in FIG. 14, the user name representing the user who owns the smart phone 3 and an account name are stored as the user information. In the example shown in FIG. 14, a user name “Hashidate” is stored as the information representing the owner of the smart phone 3. Moreover, information representing the type of a device and resolution information of a display are stored as the device information of the smart phone 3 itself.

Next, the operation of downloading a document file of a workspace to the smart phone 3 will be described.

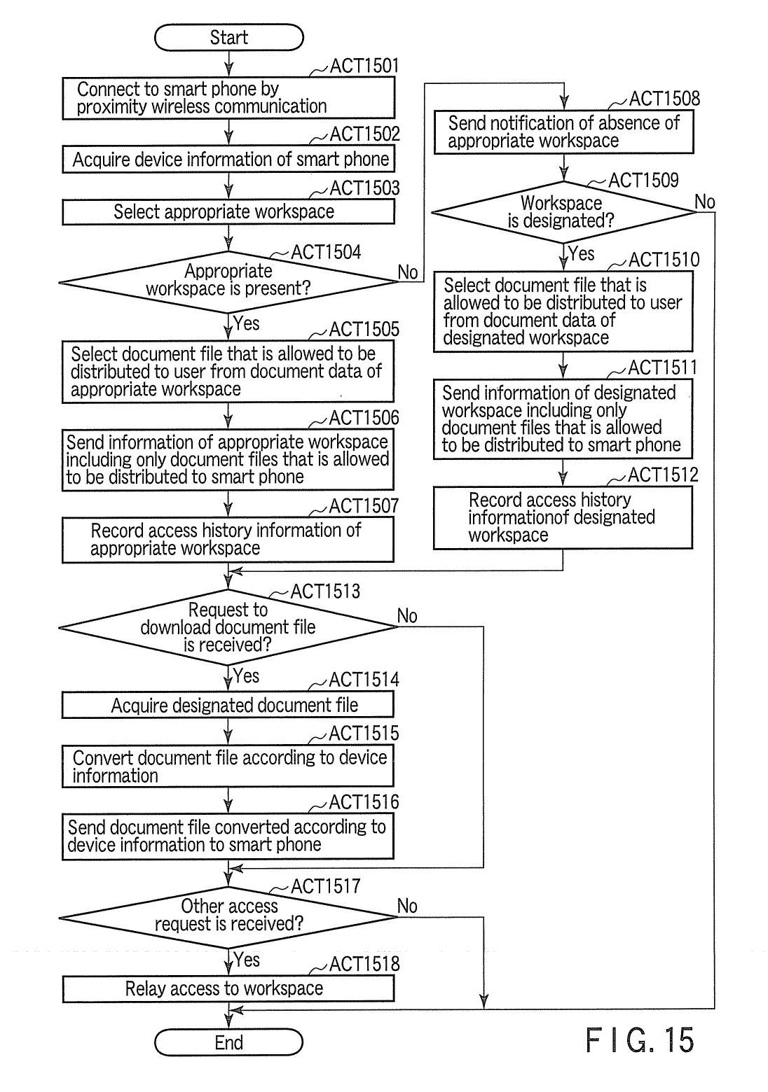

FIG. 15 is a flowchart showing the operation of allowing the smart phone 3 to download a document file of a workspace.

First, if a user brings the smart phone 3 close to the relay 4, the processor 41 performs a communication connection operation for establishing proximity wireless communication between the proximity wireless communication unit 46 and the proximity wireless communication unit 36 of the smart phone 3 (ACT 1501). If the communication connection with the smart phone 3 is established, the processor 41 acquires the mobile device information stored in the mobile device information storage unit 1203 of the smart phone 3 (ACT 1502). Upon acquiring the mobile device information, the processor 41 causes the appropriate workspace specifying unit 64 to select an appropriate workspace appropriate for the unique information of the relay 4 from the workspaces managed by the workspace management unit 61 (ACT 1503).

The processor 41 determines whether or not there is an appropriate workspace that is appropriate for the unique information of the relay 4 (ACT 1504). If there is the appropriate workspace that is appropriate for the unique information of the relay 4 (ACT 1504: YES), the processor 41 classifies the document files of the appropriate workspace based on the user information included in the mobile device information acquired from the smart phone 3 by the function of the distribution destination limiting unit 1201, into document files that are allowed to be distributed to the user and document files that are not allowed to be distributed to the user (ACT 1505). For example, the distribution destination limiting unit 1201 classifies the document files into document files that are to be distributed to the smart phone 3 and document files that are not to be distributed by comparing the user name (the user name of the smart phone 3) included in the mobile device information acquired from the smart phone 3 with the distribution destination user name set in the document files of the appropriate workspace. That is to say, the distribution destination limiting unit 1201 determines the document file in which the user name of the smart phone 3 is included in the distribution destination as the document file that is to be distributed and determines the document file in which the user name of the smart phone 3 is not included in the distribution destination as the document file that is not to be distributed.

If the document files of the appropriate workspace are classified, the processor 41 transmits information of the appropriate workspace including only the document files that are allowed to be distributed to the user to the smart phone 3 (ACT 1506). Moreover, if the information of the appropriate workspace is transmitted, the processor 41 causes the workspace access history storage unit 65 of the smart phone 3 to store access history information representing that an access to the appropriate workspace was made (ACT 1507).

Moreover, if there is no appropriate workspace that is appropriate for the unique information of the relay 4 (ACT 1504: NO), the processor 41 sends a notification to the smart phone 3 informing that there is no appropriate workspace (ACT 1508). After sending the notification to the smart phone 3 informing that there is no appropriate workspace, the processor 41 receives an access request for an accessed workspace that is designated based on the access history information stored in the workspace access history storage unit 65 of the smart phone 3.

If there is an access request for the accessed workspace, the processor 41 determines whether or not there is a designation of a workspace based on the user information included in the mobile device information acquired from the smart phone 3 (ACT 1509). If it is determined that there is a designation of a workspace (ACT 1509: YES), the processor 41 classifies the document files of the designated workspace by the function of the distribution destination limiting unit 1201 into document files that are allowed to be distributed to the user and document files that are not allowed to be distributed (ACT 1510).

If the document files of the designated workspace are classified into document files that are allowed to be distributed and document files that are not allowed to be distributed, the processor 41 transmits only the document files that are allowed to be distributed to the user to the smart phone 3 as the document data of the designated workspace (ACT 1511). In this case, the processor 41 updates the access history information of the designated workspace stored in the workspace access history storage unit 65 of the smart phone 3 (ACT 1512).

For example, a case where the smart phone 3 having the device information shown in FIG. 14 acquires the information of the meeting workspace of the item 302 shown in FIG. 13 will be considered. In the device information shown in FIG. 14, the user name is “Hashidate.” Therefore, the relay 4 transmits only the document file in which “Hashidate” is set as the distribution destination to the smart phone 3 as the document data of the workspace. That is to say, in the meeting workspace of the item 302, although “Hashidate” is set as the distribution destination in the document file of the item 304′, “Hashidate” is not set as the distribution destination in the document file of the item 305′. Therefore, the relay 4 sends only the document file of the item 304′ to the smart phone 3 of “Hashidate” as the meeting workspace of the item 302.

Moreover, after sending the information of the appropriate workspace or after sending the information of the designated accessed workspace, the processor 41 performs processing in response to an access request for the appropriate workspace from the smart phone 3. The smart phone 3 is able to issue an instruction to access the workspace on the display screen shown in FIG. 8. The processor 41 determines whether or not there is a request from the smart phone 3 to download one document file (ACT 1513). If there is a request from the smart phone 3 to download one document file (ACT 1513: YES), the processor 41 acquires the designated document file from the workspace management server 1 with the help of the workspace access relay unit 63 (ACT 1514).

Upon acquiring the designated document file from the workspace management server 1, the processor 41 converts the acquired document file into a document format corresponding to the mobile device information acquired from the smart phone 3 with the help of the document format converting unit 1202 (ACT 1515). For example, if the display resolution of the display unit 34 of the smart phone 3 is identified from the device information, the processor 41 performs a layout adjustment operation of enlarging small characters in the document file or reducing a large-width table to be displayed within a display screen according to the resolution of the display unit 34 with the help of the document format converting unit 1202. If the document format of the document file is converted according to the device information of the smart phone 3 by the document format converting unit 1202, the processor 41 sends the converted document file to the smart phone 3 (ACT 1516).

Moreover, the processor 41 determines whether or not an access request other than downloading of the document file is received (ACT 1517). If an access request other than downloading of the document file is received (ACT 1517: YES), the processor 41 performs a relay operation of allowing an access to the workspace in response to the request from the smart phone 3 (ACT 1518).

As described above, in the document system according to the second embodiment, the relay distributes the document files of the workspaces stored in the workspace management server only to the mobile devices of the users who are set as the distribution destination in advance. Therefore, it is possible to set the distribution destination for each document file rather than for all the workspaces. Moreover, if the document file is distributed, the relay changes the layout of the document file according to the displaying capability of the display unit of the distribution destination mobile device. Therefore, the mobile device is able to display the document file of the workspace acquired via the relay in an easy-to-view layout.

Next, the third embodiment will be described.

The document system according to the third embodiment can be realized by the same hardware configuration as the first embodiment shown in FIG. 1. Therefore, detailed description of the hardware configuration of the document system according to the third embodiment will be omitted. In the third embodiment, it will be assumed that the MFP 5 has a function (private printing function) wherein a print operation of a private print job registered by the PC 2 is executed according to an instruction of a user who is authenticated by user authentication.

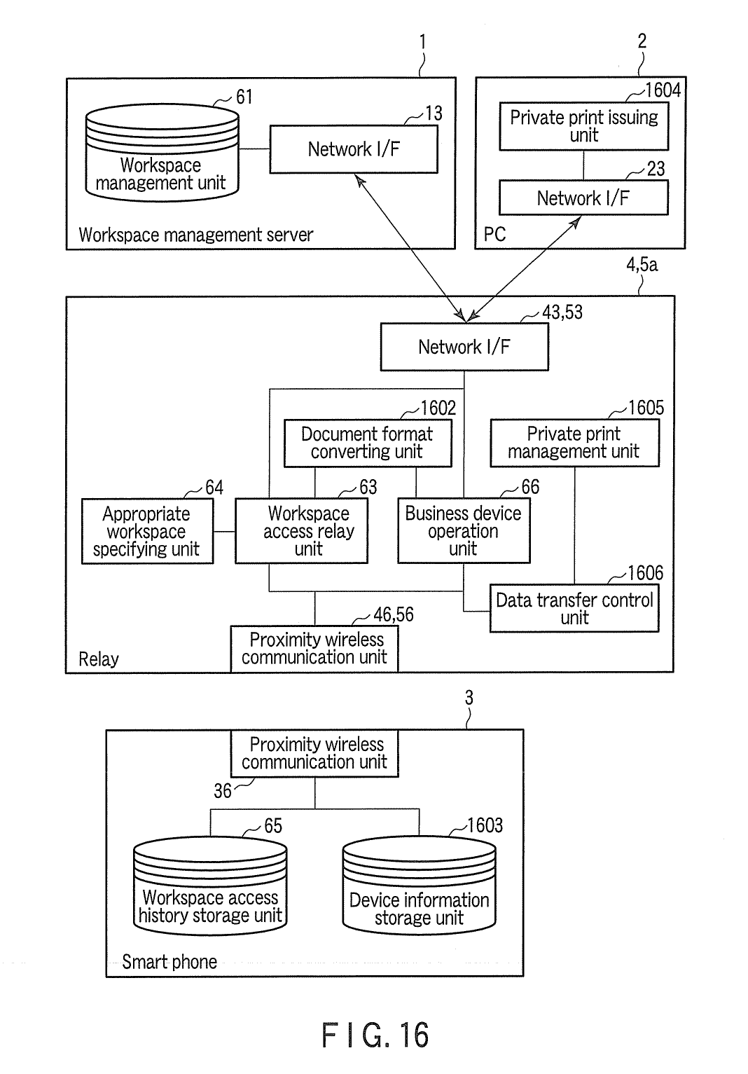

FIG. 16 is a diagram showing an exemplary functional configuration of the document system according to the third embodiment.

As shown in FIG. 16, the document system of the third embodiment includes network interfaces 13, 23, 43, and 53, proximity wireless communication units 36, 46, and 56, a workspace management unit 61, a workspace access relay unit 63, an appropriate workspace specifying unit 64, a workspace access history storage unit 65, a business device operation unit 66, a document format converting unit 1602, a mobile device information storage unit 1603, a private print issuing unit 1604, a private print management unit 1605, and a data transfer control unit 1606.

The network interfaces 13, 23, 43, and 53, the proximity wireless communication units 36, 46, and 56, the workspace management unit 61, the workspace access relay unit 63, the appropriate workspace specifying unit 64, the workspace access history storage unit 65, and the business device operation unit 66 are the same functional units as the functional units described in the first embodiment. Moreover, the document format converting unit 1602 and the mobile device information storage unit 1603 may have the same functions as the document format converting unit 1202 and the mobile device information storage unit 1203 described in the second embodiment.

The private print issuing unit 1604 is a functional unit that is provided to the PC 2. The private print issuing unit 1604 issues a private print job by registering the private print job to the MFP 5. The private print issuing unit 1604 is a functional unit that is implemented if the processor 21 executes a program which is installed in the PC 2 as a printer driver. That is, the processor 21 of the PC 2 issues a private print job, which means a document file designated by a user is to be printed privately, by executing the printer driver.

The private print job issued by the private print issuing unit 1604 may contain the following information: print data to be printed, an allowed user name, and the number of allowed transfer times to a mobile device. In addition, the number of allowed transfer times can be set in the print data of each private print job. Moreover, the number of allowed transfer times of the print data of a private print job may be set by a user on the PC 2, and a predetermined number of allowed transfer times may be set.

The private print management unit 1605 is a functional unit that allows the MFP 5 to store and manage a plurality of private print jobs in a unified manner. The private print management unit 1605 is a functional unit that is implemented by the processor 51 using the storage unit 52. The private print management unit 1605 is implemented if the processor 51 executes a program. The private print job issued by the private print issuing unit 1604 is transferred to the MFP 5 via the network 6. The MFP 5 stores and manages the private print job with the help of the private print management unit 1605.

FIG. 17 is a diagram showing an example of private print jobs that are managed by the private print management unit 1605. In the example shown in FIG. 17, the private print management unit 1605 manages the private print jobs by their job ID, allowed user for print, print data, number of allowed transfer times, issuance date, expiration date, and document file name. The job ID is information that is issued if the private print jobs are registered. The allowed user for print is the user who issued the corresponding private print job.

The print data are image data for printing. The print data are files that are described in page description language such as PostScript. The print data included in the private print job issued from the PC 2 are stored as files in the storage unit 52 within the MFP 5. As the print data of the private print job, the path to the print data stored in the storage unit 52 may be managed. The number of allowed transfer times is the number of times the print data can be transferred to a mobile device.

The issuance date is the date if the corresponding private print job is registered. The expiration date is the date to which the corresponding private print job is valid. The private print management unit 1605 is able to set the storage period of each private print job. In the example shown in FIG. 17, the private print jobs are managed for the storage period of 5 days. In this case, the private print management unit 1605 manages the private print jobs so that their expiration date is 5 days after their issuance date. For example, the private print management unit 1605 deletes a private print job whose expiration date has passed. The document file name is the source file name of the print data.

The data transfer control unit 1606 is a functional unit that is provided to the MFP 5. The data transfer control unit 1606 controls the operation of transferring the print data of a private print job stored in the private print management unit 1605 to the smart phone 3. The data transfer control unit 1606 determines whether or not it is allowed to transfer the print data to the smart phone 3 based on information such as the number of allowed transfer times of the private print job. Moreover, the data transfer control unit 1606 causes the business device operation unit 66 to transfer the print data which are allowed to be transferred to the smart phone 3 and causes the document format converting unit 1602 to convert the print data into a document file that can be viewed on the smart phone 3. The relay 4 does not have the private print management unit 1605 and the data transfer control unit 1606.

Next, the operation of transferring the print data of private print jobs will be described.

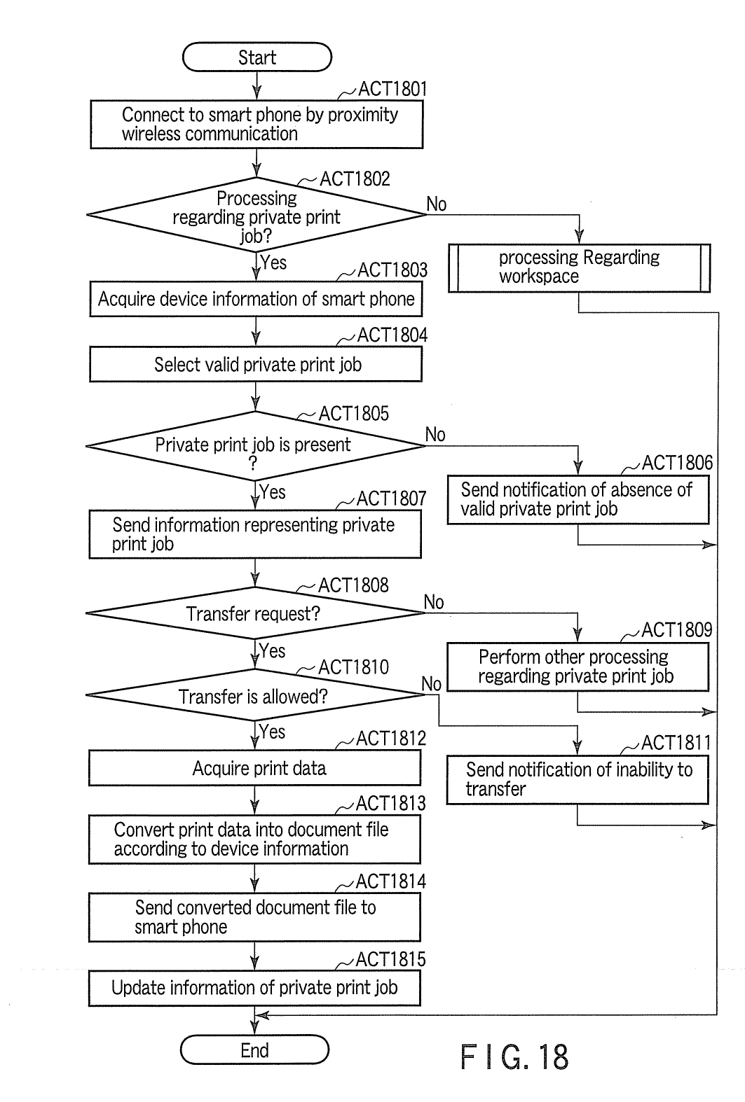

FIG. 18 is a flowchart showing the operation of transferring print data of private print jobs. In this embodiment, an operation wherein the MFP 5 having the relay 5a transfers the print data of a private print job to the smart phone 3 will be considered.

First, if a user brings the smart phone 3 close to the relay 5a (the proximity wireless communication unit 56) of the MFP 5, the processor 51 performs a communication connection operation for establishing proximity wireless communication between the proximity wireless communication unit 56 and the proximity wireless communication unit 36 of the smart phone 3 (ACT 1801). If the communication connection with the smart phone 3 is established, the processor 51 determines whether or not an operation requested by the smart phone 3 is an operation regarding a private print job (ACT 1802). It will be assumed that the user of the smart phone 3 is able to select either the operation regarding the private print job or the operation regarding the workspace described in the first or second embodiment.

In this embodiment, it will be assumed that the MFP 5 receives a request from the smart phone 3 to perform the operation regarding the private print job. For example, it will be assumed that the smart phone 3 has a private print application program which is executed by the processor 31 and which is stored in the storage unit 32. If communication connection with the relay 5a of the MFP 5 is established in the state where the private print application is activated, the processor 31 of the smart phone 3 is able to send a request to perform the operation regarding the private print job. The operation regarding the workspace can be performed by connecting the smart phone 3, in which the workspace access application is activated, to the relay 5a of the MFP 5 as described in the first embodiment.

If connection with the smart phone 3 that sends the request to perform the operation regarding the private print job (ACT 1802: YES) is established, the processor 51 acquires the mobile device information stored in the mobile device information storage unit 1203 from the smart phone 3 (ACT 1803). The mobile device information includes, for example, the device information of the smart phone 3 itself and the user information as shown in FIG. 14. The processor 51 selects a private print job of the user of the smart phone 3 from the private print jobs managed by the private print management unit 1605 based on the user information included in the device information acquired from the smart phone 3 (ACT 1804).

The processor 51 determines whether or not there is a private print job of the user (ACT 1805). If there is no private print job of the user (ACT 1805: NO), the processor 51 sends a notification to the smart phone 3 informing that there is no private print job of the user (ACT 1806). If sending the notification of absence of the appropriate workspace, the processor 51 ends the above-described processing.

Moreover, if there is a private print job of the user (ACT 1805: YES), the processor 51 sends information representing a private print job of the user to the smart phone 3 with the help of the data transfer control unit 1606 (ACT 1807). For example, if the user name acquired from the smart phone 3 is “Hashidate,” the processor 51 transfers the information of a private print job whose job ID is “2” among the private print jobs shown in FIG. 17 to the smart phone 3.

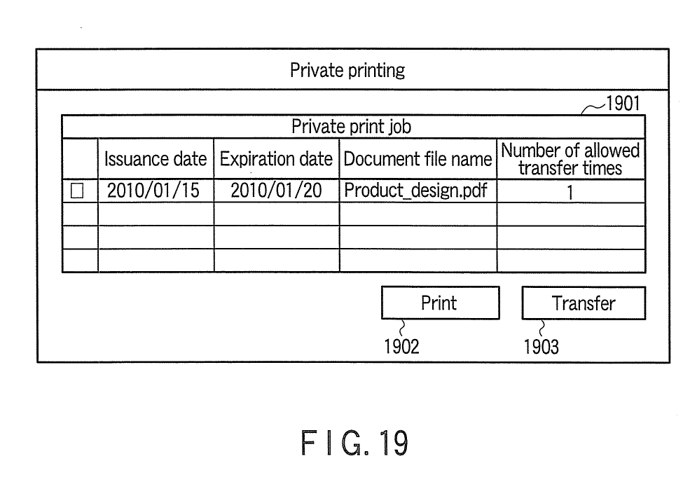

Upon receiving the information of the private print jobs from the MFP 5, the processor 31 of the smart phone 3 displays the received private print jobs on the display unit 34 in a list form. FIG. 19 is a diagram showing a display example of private print jobs. In the display example shown in FIG. 19, a table 1901, a Print button 1902, and a Transfer button 1903 are displayed. The table 1901 is a display section in which the private print jobs of the user are displayed in a list form. The user is able to select one private print job from the private print jobs displayed in the table 1901. The Print button 1902 is a button for instructing the printing of the selected private print job. The Transfer button 1903 is a button for instructing the transferring of the document file as the print data of the selected private print job.

After sending the information representing the private print job of the user, the processor 51 receives a request from the smart phone 3 to perform the operation regarding the private print job. For example, the user of the smart phone 3 is able to instruct printing or transferring of the private print job in the display example shown in FIG. 19. The processor 51 determines whether or not there is a request from the smart phone 3 to perform an operation other than the transfer operation such as printing of the private print job (ACT 1808). If there is a request from the smart phone 3 to perform an operation other than the transfer operation such as printing of the private print job (ACT 1808: NO), the processor 51 executes the requested operation regarding the designated private print job (ACT 1809).

For example, if the user clicks on the Print button in the display example shown in FIG. 19, the processor 31 of the smart phone 3 sends a request to the MFP 5 to execute printing of the private print job in the selected state. If there is a request from the smart phone 3 to execute printing of the private print job, the MFP 5 executes printing of the selected private print job. In this case, the MFP 5 executes the private printing on condition that the smart phone 3 succeeded in user authentication.

Moreover, if there is a request from the smart phone 3 to transfer the print data of the private print job (ACT 1808: YES), the processor 51 acquires the information of the private print job managed by the private print management unit 1605 and determines whether or not it is allowed to transfer the print data of the private print job (ACT 1810). The processor 51 determines whether or not it is allowed to transfer the print data of the private print job based on the number of allowed transfer times that is set as the information of the designated private print job.

If it is determined that it is not allowed to transfer the print data of the designated private print job (ACT 1810: NO), the processor 51 sends a notification to the smart phone 3 informing that it is not allowed to transfer the print data of the designated private print job (ACT 1811). In this case, the processor 51 may inform the smart phone 3 of the reasons why the transferring is not allowed. Upon receiving such a notification, the processor 31 of the smart phone 3 displays a message on the display unit 34 informing that it is not allowed to transfer the print data of the selected private print job.

Moreover, if it is determined that it is allowed to transfer the print data of the designated private print job (ACT 1810: YES), the processor 51 acquires the print data of the designated private print job (ACT 1812). Upon acquiring the print data of the private print job, the processor 51 converts the acquired print data into a document file having the original data format with the help of the document format converting unit 1602 (ACT 1813).

For example, the processor 51 converts the print data into an original document file based on the data format (extension) of the source file of the print data stored as the information of the private print job. Moreover, the print data of the private print job may be converted into a document file having a data format that is set in advance considering its view on the smart phone 3. Furthermore, the print data of the private print job may be converted into a document file having a data format corresponding to the device information of the smart phone 3. In this case, the smart phone 3 may describe the data format of a viewable document file in its device information of the mobile device information.

In addition, the processor 51 may cause the document format converting unit 1602 to perform a layout adjustment operation on the document files converted from the print data of the private print job, wherein the layout adjustment operation involves enlarging small characters in the document file or reducing a large-width table to be displayed within a display screen according to the displaying capability of the display unit 34 which is described in the device information of the smart phone 3. The processor 51 sends the document files converted by the document format converting unit 1602 to the smart phone 3 (ACT 1814). If sending the document files to the smart phone 3, the processor 51 updates the information of the private print job such as the number of allowed transfer times (ACT 1815).

As described above, in the document system according to the third embodiment, the MFP acquires the user information from the smart phone 3 by proximity wireless communication. If there is a private print job of a user who is identical to the user of the smart phone 3, the MFP transfers the print data registered as a private print job to the smart phone without printing the data in response to a user's instruction from the smart phone. Moreover, the MFP converts the print data to be transferred to the smart phone into a document file that can be viewed on the user's smart phone and changes the layout of the document file so as to be easily viewed on the display unit of the user's smart phone. In this way, the user is able to acquire the print data of the private print job and view the data on the smart phone 3 just by bringing the smart phone 3 close to the MFP 5.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data providing method performed by a relay, the method comprising:
performing contactless communication with a mobile device brought close to the relay;
selecting an appropriate workspace that is appropriate for unique information representing the status of the contactless communication with the mobile device from a plurality of workspaces that collects a plurality of information related to each task;
sending information of the selected appropriate workspace to the mobile device by the contactless communication; and
causing the relay to allow the mobile device to access the appropriate workspace in response to an access request for the appropriate workspace from the mobile device.

2. The method according to claim 1,
wherein the relay classifies document files of the selected appropriate workspace into document files that are allowed to be distributed to the mobile device and document files that are not allowed to be distributed, and
the information of the appropriate workspace in which only the document files that are allowed to be distributed to the mobile device are included as its document files is sent to the mobile device by the contactless communication.

3. The method according to claim 1, further comprising:
causing the relay to acquire device information representing a processing capability from the mobile device by contactless communication; and
converting the document files included in the workspace according to the processing capability of the mobile device described in the device information before the document files are transferred to the mobile device.

4. The method according to claim 1, further comprising:
storing access history information representing workspaces that was accessed by the mobile device; and
causing the relay to allow the mobile device to access a workspace selected from the workspaces that are described in the access history information.

5. The method according to claim 1,
wherein the unique information is information representing the communication date and time if the relay made contactless communication with the mobile device, and
a workspace in which the communication date and time of the unique information is appropriate for the execution date and time or the execution place of the task is selected as the appropriate workspace.

6. The method according to claim 1,
wherein if the mobile device accesses the appropriate workspace, the mobile device issues a print instruction to print document data belonging to the appropriate workspace or a storage instruction to store scanned document data in the appropriate workspace, and
the relay operates an image forming apparatus based on the print instruction or the storage instruction.

7. An image forming apparatus comprising:
a memory that stores print data of print jobs for each user;
a wireless communication unit that performs contactless communication;
an information acquisition unit that acquires user information from a mobile device that is connected by the contactless communication of the wireless communication unit; and
a transfer unit that transfers print data of print jobs of a user identified by the user information that is acquired from the mobile device by the information acquisition unit to the mobile device by the contactless communication of the wireless communication unit if a request to transfer the print job is received from the mobile device connected by the contactless communication of the wireless communication unit.

8. The apparatus according to claim 7, further comprising a sending unit that sends information representing the print jobs of the user identified by the user information acquired by the information acquisition unit to the mobile device,
wherein the transfer unit transfers print data of a print job selected from the print jobs sent from the sending unit to the mobile device.

9. The apparatus according to claim 7,
wherein the memory stores the number of allowed transfer times of a print job, and
the apparatus further comprises a determination unit that determines whether or not it is allowed to transfer a print job based on the number of allowed transfer times of the print job that the mobile device requested to transfer.

10. The apparatus according to claim 7, further comprising a converting unit that converts the print data into a document file having a data format that can be displayed by the mobile device,
wherein the transfer unit transfers a document file of the print data, whose data format is converted by the converting unit, to the mobile device.

11. The apparatus according to claim 10, wherein the converting unit converts the print data into a data format of an original document file.

12. The apparatus according to claim 10, wherein the converting unit converts the print data into a document file having a data format that is set in advance.

13. The apparatus according to claim 10,
wherein the information acquisition unit acquires device information representing a processing capability of the mobile device by the contactless communication of the wireless communication unit, and
the converting unit converts the print data into a document file corresponding to the processing capability of the mobile device that is described in the device information acquired by the information acquisition unit.

14. A data providing method performed by an image forming apparatus, the method comprising:
storing print data of print jobs for each user in a memory;
acquiring user information from a mobile device that is connected by contactless communication; and
transferring print data of a print job of a user identified by the user information that is acquired from the mobile device by the contactless communication if a request to transfer the print job is received from the mobile device connected by the contactless communication.

15. The method according to claim 14, further comprising:
sending information representing the print jobs of the user identified by the user information acquired from the mobile device to the mobile device; and
transferring print data of a print job selected from the sent print jobs by the contactless communication.

16. The method according to claim 14,
wherein the number of allowed transfer times of each print job is stored in the memory, and
a determination is made as to whether or not it is allowed to transfer the print job based on the number of allowed transfer times of the print job that the mobile device requested to transfer.

17. The method according to claim 14,
wherein the print data of the print job that is requested to transfer are converted into a document file having a data format that can be displayed by the mobile device, and
a document file of the print data, whose data format is converted by the converting, is transferred to the mobile device.

18. The method according to claim 17, wherein the print data of the print job that is requested to transfer are converted into a data format of an original document file.

19. The method according to claim 17, wherein the print data of the print job that is requested to transfer are converted into a document file having a data format that is set in advance.

20. The method according to claim 17, further comprising acquiring device information representing a processing capability of the mobile device that is connected by the contactless communication,
wherein the print data of the print job that is requested to transfer are converted into a document file corresponding to the processing capability of the mobile device that is described in the acquired device information.
